(19) United States
(12) Patent Application Publication
(10) Pub. No.: US 2016/0252484 A1
(43) Pub. Date: Sep. 1, 2016

(54) SYSTEM AND METHOD FOR MODIFIED GAS CHROMATOGRAPHIC DATA ANALYSIS

(71) Applicant: SPECTROSENSE LTD., Rehovot (IL)

(72) Inventor: Avi RUBINSTEIN, Ramot Meir (IL)

(21) Appl. No.: 15/027,897

(22) PCT Filed: Oct. 8, 2014
(86) PCT No.: PCT/IL14/50894

§ 371 Date: Apr. 7, 2016

Related U.S. Application Data
(60) Provisional application No. 61/888,625, filed on Oct. 9, 2013.
(60) Provisional application No. 62/060,890, filed on Oct. 7, 2014.

(51) Int. Cl. G01N 30/86; G06F 19/00

(52) U.S. Cl. CPC G01N 30/8637; G06F 19/3437; G01N 30/8693

(57) ABSTRACT

A method that employs self-reliant gas chromatography for determining a measure of match between acquired gas chromatographic data representative of a sample and reference gas chromatographic data, the acquired gas chromatographic data includes at least one observed chromatographic peak, the reference gas chromatographic data includes at least one reference chromatographic peak, the at least one observed chromatographic peak and the at least one reference chromatographic peak are characterized by at least one temporal attribute and at least one shape attribute, the method includes at least the procedure of: estimating respectively, for said at least one observed chromatographic peak, said measure of match according to a degree of fitness between an observed value and respective a reference value of said at least one shape attribute.

### FIELD OF THE DISCLOSED TECHNIQUE

The disclosed technique relates to gas chromatography in general, and methods and systems for analyzing gas chromatographic data, in particular.

### BACKGROUND OF THE DISCLOSED TECHNIQUE

Gas liquid partition chromatography (GLPC), vapor-phase chromatography (VPC), gas-liquid chromatography, also known more simply as gas chromatography (GC), are names of analytical chemistry techniques employed for separating and analyzing chemical mixtures or compounds that can be vaporized without chemical decomposition. GC is utilized for separating a sample, such as a gaseous mixture into its chemical constituents, where the relative quantities of the constituents may be determined. GC may also be employed for testing the purity of substances, compounds, and mixtures for assisting in the identification of compounds, and for the preparation of pure compounds from a mixture. GC is performed by an instrument, generally termed a gas chromatograph or gas separator. Generally, the GC technique involves introducing a sample, in vaporized form (e.g., via direct injection, purge-and-trap (P/T) techniques), into one end of a GC column (hereinafter “column”), internally constructed to have an inert solid support coated with different solid or liquid stationary phases (i.e., absorbents). A mobile phase (i.e., a carrier gas, such as helium) is employed to sweep the sample through the column. Disparate constituents of the sample interact differently with the stationary phase, as the sample is swept through the column, causing each constituent to elute at a different time (i.e., known as the retention time of the constituent). The rates at which the different chemical constituents of the sample pass through the column depend on their chemical and physical properties as well as their interaction with the stationary phase. As the constituents emerge from the other end of the column at different times, depending on each of their respective retention times, they may be detected by detectors employing various detection techniques. The detector typically produces an electrical signal in response to the concentration of the constituents in the sample. The chromatographic data is typically presented in the form of a graph (e.g., a spectrum) of the detector response (concentration) as a function of the time (retention time), referred to as a chromatogram. Consequently, for each sample, the GC produces a corresponding chromatogram having a spectrum of peaks, which represent the analytes present in the sample eluting from the column at different times. By quantitatively analyzing the spectral patterns present in the chromatogram of the sample, by comparing them to a certain standard containing known concentrations of analytes, it is possible to determine the concentration of the analyte in the sample.

Consequently, GC is employed in a wide diversity of fields, such as in biomedical applications, environmental applications, in forensic analysis, petrochemical analysis, etc. For example, GC is employed in the analysis of exhaled human and animal breath for volatile organic compounds (VOCs). VOCs, in general, are gases or vapors that are emitted by various materials (e.g., cleaning supplies, paint, pesticides, building materials) that may pose adverse health effects to living beings. Humans are naturally exposed to VOCs through inhalation, ingestion, skin absorption, and the like. By examining exhaled human breath, which naturally contains hundreds of VOCs, it is possible provide an indication to potentially deleterious build-up of chemicals in the body. Detected VOC's in exhaled human breath may thus serve as biological markers (i.e., biomarkers) in testing for the likelihood of the presence of diseases such as lung cancer, breast cancer, diabetes, and schizophrenia.

It is known, however, that the analysis of chromatographic data, particularly the complete separation and resolution of a sample into its constituents may be difficult due to the occurring phenomenon of overlapping peaks that are present in chromatograms. Basically, this problem arises when two or more different constituents of a sample elute at substantially the same rate (i.e., they substantially have similar retention times) and are detected as though they were a single component.

Various types of apparatuses and chromatographic separation methods are known in the art. One such method for enhancing the detection of overlapping chromatographic peaks involves the use of multi-dimensional gas chromatography (herein abbreviated MDGC), where components of the sample are subject to two or more separation steps using two or more columns that possess different characteristics. In two-dimensional (2-D) gas chromatography (herein abbreviated 2D-GC), for example, regions in the chromatogram which require additional analysis are enriched (“heart-cut”) and assayed on a second column. Another method involves the use of comprehensive 2D-GC (herein abbreviated GC×GC), which is based on the collection of effluent from a first column and periodic re-injection of portions of the effluent into a second column having different properties. In this method, effluent from the first column is sampled multiple times such that the entire sample is subjected to all of the separation steps (i.e., dimensions), while preserving the separation from each previous step. This method relies on an interface that connects the first and second columns, which enables periodic injection to occur. Nonetheless, the use of these techniques entails additional equipment as well as the analysis of multiple channels of spectral data, which ultimately do not guarantee complete identification of all components that comprise a particular sample.

Methods and systems for analysis of gas chromatographic data are also known in the art. For example, it is known in the art to employ exponentially modified Gaussian (EMG) functions in characterizing the shape of chromatographic peaks, the theoretical justifications of which lie in the fact that chromatographic peaks usually exhibit asymmetrical properties. Other methods include deconvolution techniques, iterative target transform factor analysis (ITTFA), pattern recognition and neural network techniques, and the like. U.S. Pat. No. 7,403,859 B2 to Ito et al., entitled “Method and Apparatus for Chromatographic Data Processing” is directed to a liquid chromatographic analyzer for facilitating curve fitting by employing a linear least-square method for a chromatogram that contains a plurality of overlapping peaks. The liquid chromatic analyzer includes a column, a sample supply portion, a fluid pump, a controller, a sampler, and a detector. The sample supply portion is arranged between the fluid pump and the column. An eluting solution is pumped to the column using the fluid pump by instruction from the controller. A sample is supplied from the sampler to the eluting solution by instruction of the controller. The sample is separated by the column and detected by the detector. A chromatogram of the detected data is transmitted to the controller to be analyzed.

Data processing of the chromatogram by the controller is executed by a procedure that includes specification of a time interval to execute fitting, selecting a waveform function, selection of a weighting pattern, selection of a fitting direction, clicking of the fitting execution button, and displaying and outputting of the result. Initially, for a particular selected chromatogram, a time interval in the chromatogram is selected for fitting by inputting a starting time and an ending time. Subsequently, a Gaussian or EMG function is used as the waveform function for fitting. The selection of the weighing function involves superimposing a graphical representation of the weighing function onto the chromatogram via a pointing device. The selection of the fitting direction involves setting of the direction whether the processing is to be executed from the front side or the back side of the selected time interval in the chromatogram. The fitting processing (execution) utilizes a waveform function for fitting, which is a sum of Gaussian functions and a base line (i.e., a linear line equation). The fitting processing employs a least-square method such that the fitting parameters in the Gaussian functions are determined so as to minimize the sum of the square of the differences between the waveform function and the respective points in the signal intensity of the measured chromatogram.

### SUMMARY OF THE DISCLOSED TECHNIQUE

It is an object of the disclosed technique to provide a novel system and method employing gas chromatography, which overcomes the disadvantages of the prior art. In accordance with the disclosed technique, there is thus provided a method that employs self-reliant gas chromatography for determining a measure of match between acquired gas chromatographic data representative of a sample and reference gas chromatographic data. The acquired gas chromatographic data includes at least one observed chromatographic peak, and the reference gas chromatographic data includes at least one reference chromatographic peak. The at least one observed chromatographic peak and the at least one reference chromatographic peak are characterized by at least one temporal attribute and at least one shape attribute. The method includes the procedures of determining respectively, for the at least one observed chromatographic peak, at least one parameter in a modeling function, associating respectively, for the at least one observed chromatographic peak the at least one reference chromatographic peak, and estimating respectively, for the at least one observed chromatographic peak, the measure of match according to a degree of fitness between the observed value and respective reference value of the at least one shape attribute, according to the procedure of associating. The determination of at least one parameter in a modeling function is performed such to substantially fit the modeling function to the at least one observed chromatographic peak. The at least one parameter includes at least one of the at least one shape attribute. The method of associating the at least one observed chromatographic peak with the at least one reference chromatographic peak is according to: a degree of correspondence between an observed value of the at least one shape attribute of the at least one observed chromatographic peak, and a reference value of respective at least one shape attribute of the at least one reference chromatographic peak; and a degree of correspondence between an observed value of the at least one temporal attribute of the at least one observed chromatographic peak, and a reference value of the respective at least one reference temporal attribute of the at least one reference chromatographic peak.

According to another aspect of the disclosed technique, there is thus provided a self-reliant gas chromatography system for analysis of gas chromatographic data. The system includes a chromatographic separation column for separating a sample into a plurality of constituents, a sample delivery device, a detector, a memory device, and a processor. The chromatographic separation column includes an inlet and outlet. The sample delivery device is coupled with the chromatographic separation column at the inlet thereof, in order to provide the sample to the chromatographic separation column. The detector, which is in communication with the outlet of the chromatographic separation column, detects at least a portion of the plurality of constituents and produces a signal that includes the gas chromatographic data respective of the characteristics of the detected portion of the sample. The memory device, which is coupled with the processor, stores the gas chromatographic data and a plurality of reference data. The processor, which is coupled with the detector, determines respectively, for the at least one observed chromatographic peak, at least one parameter in a modeling function, such to substantially fit the modeling function to the at least one observed chromatographic peak. The at least one parameter includes at least one of the at least one shape attribute. The processor associates respectively, for the at least one observed chromatographic peak at least one reference chromatographic peak according to: a degree of correspondence between an observed value of the at least one shape attribute of the at least one observed chromatographic peak, and a reference value of the respective at least one shape attribute of the at least one reference chromatographic peak; and a degree of correspondence between an observed value of the at least one temporal attribute of the at least one observed chromatographic peak, and a reference value of the respective at least one reference temporal attribute of the at least one reference chromatographic peak. The processor estimates respectively, for the at least one observed chromatographic peak, the measure of match according to a degree of fitness between the observed value and the respective reference value of the at least one shape attribute.

### BRIEF DESCRIPTION OF THE DRAWINGS

The disclosed technique will be understood and appreciated more fully from the following detailed description taken in conjunction with the drawings in which:

FIG. 1 is a schematic illustration of a system for analysis of gas chromatographic data, constructed and operative according to an embodiment of the disclosed technique;

FIG. 2A is a schematic illustration of a representative chromatogram, acquired by the system illustrated in FIG. 1;

FIG. 2B is a schematic illustration of a graph of an initial estimate of a time-dependent modeling function, modeled according to the chromatogram of FIG. 2A;

FIG. 2C is a schematic illustration of a graph of the calculated time-dependent model error resulting from the initially estimated modeling function of FIG. 2B, plotted in conjunction with a graph of a time-dependent model error threshold function;

FIG. 2D is a schematic illustration of a refined estimate of the time-dependent modeling function of FIG. 2B, modeled according to the chromatogram of FIG. 2A;

FIG. 3A is a schematic block diagram illustrating the method for resolving and identifying components within overlapping chromatographic peaks whose different constituents compose a given sample, constructed and operative according to the embodiment of the disclosed technique;

FIG. 3B is a schematic block diagram illustrating a continuation of the method of FIG. 3A;

FIG. 4 is a schematic diagram illustrating fitting of a modeling function to an observed chromatographic peak for the determination of observed shape attribute values of the observed chromatographic peak;

FIG. 5 is a schematic diagram illustrating the process of associating observed chromatographic data with reference chromatographic data according to the degree of correspondence of various criteria therebetween;

FIG. 6 is a schematic illustration showing a representation of observed and reference chromatographic data in the shape parameter versus time domain;

FIG. 7 is a schematic illustration showing cluster analysis techniques employed to assess whether observed chromatographic data are linked with reference chromatographic data within the shape parameter versus time domain;

FIG. 8A is a schematic block diagram illustrating a method that employs self-reliant gas chromatography for determining a measure of match between acquired gas chromatographic data respective of a sample and reference data, constructed and operative according to a further embodiment of the disclosed technique;

FIG. 8B is a schematic block diagram illustrating a continuation of the method from FIG. 8B;

FIG. 9A is a 2-dimensional scatter plot of experimental results yielded in a construction phase of a database of reference chromatographic data, plotted in the shape attribute versus time domain; and

FIG. 9B illustrates 2-dimensional graphs representing modeled gamma distribution functions of the reference chromatographic data, taken from a portion of FIG. 9A, graphed in the gamma distribution function value versus time domain.

### DETAILED DESCRIPTION OF THE EMBODIMENTS

The disclosed technique overcomes the disadvantages of the prior art by providing a method and system for resolving and identifying components within overlapping chromatographic peaks whose different constituents compose a given sample, by employing a modeling function defined as a sum of a linear combination of probability density functions. Chromatographic data associated with the chemical constituents that compose the given sample is acquired by one-dimensional GC (herein abbreviated 1D-GC) gas chromatographic separation techniques (i.e., in contrast to multi-dimensional gas chromatographic techniques, such as MDGC and 2D-GC). Significant features (e.g., chromatographic peaks) within a chromatogram of the sample are mathematically decomposed, in such a way that they may be classified, and thereafter represented (i.e., modeled) by a particular type of probability density function according to the implemented classification. A plurality of parameters characterizing each of the probability density functions are estimated by optimization techniques and thereafter, a plurality of linear coefficient parameters in the sum of the linear combination of probability density functions are determined by a least squares approach. A time-dependent model error function and a model error threshold parameter are defined. Chromatographic peaks suspected of being composite are substantially determined (i.e., assessed, estimated) by initially evaluating the time values for which the time-dependent model error threshold parameters exceed the time-dependent model error. A refined modeling function is constructed by remodeling the peaks suspected of being composite by a plurality of probability density functions, taking into account the corresponding model error of each respective peak, thereby resolving composite chromatographic peaks. The optimization techniques are repeated in order to substantially fit the modeling function to the chromatographic data, so as to minimize the least square error. At each iteration, the refined modeling function substitutes the previous modeling function until the model error is minimized. The disclosed technique estimates a measure of match between reference peaks, the information of which is stored in a database, and the plurality of peaks including the newly discovered and resolved peaks of the sample, in order to deduce the presence or absence of particular biomarkers of interest in the analyzed sample. Generally, the disclosed technique may typically be implemented for providing a probabilistically determined indication of the presence of multi-biomarkers in a breath sample, collected from individual suspected of having a particular adverse medical condition (e.g., cancer).

According to another embodiment of the disclosed technique, the representation and analysis of chromatographic data is performed in a domain which is different to that employed in conventional GC analysis. In conventional GC analysis, chromatographic data is typically represented in the form of chromatograms that record the concentration of eluted materials (i.e., the detector response) as a function of time (e.g., retention time), hence in the concentration versus retention time domain. In the present embodiment, chromatographic data is represented and analyzed in terms of various shape attributes of the probability distribution functions (PDFs) that respectively model chromatographic peaks as a function of time, hence in the PDF shape attribute versus time domain. A shape attribute of a PDF is defined herein as an attribute or feature that may be used to characterize a PDF, such as one of its shape parameters, its scale parameter, its maximum value, its mean value, its variance, its kurtosis, and the like. Since chromatographic peaks exhibit varying characterizing shapes in time or characteristic “propagating spreads” in time, they have characteristic distributions that may be mathematically modeled by PDFs and their shape parameters. The disclosed technique thus offers to represent and analyze chromatographic data in the chromatographic-peak-characterizing-shape versus time domain.

In accordance with this embodiment there is provided a system and method that employ self-reliant gas chromatography for determining a measure of match between acquired gas chromatographic data representative of a sample and reference gas chromatographic data. The acquired gas chromatographic data includes at least one observed chromatographic peak, and the reference gas chromatographic data includes at least one reference chromatographic peak. The at least one observed chromatographic peak and the at least one reference chromatographic peak are characterized by at least one temporal attribute and at least one shape attribute. The system includes a chromatographic separation column for separating a sample into a plurality of constituents, a sample delivery device, a detector, a memory device, and a processor. The chromatographic separation column includes an inlet and outlet. The sample delivery device is coupled with the chromatographic separation column at the inlet thereof, in order to provide the sample to the chromatographic separation column. The detector, which is in communication with the outlet of the chromatographic separation column, detects at least a portion of the plurality of constituents and produces a signal that includes the gas chromatographic data respective of the characteristics of the detected portion of the sample. The memory device, which is coupled with the processor, stores the gas chromatographic data and a plurality of reference data. The processor is coupled with the detector. The processor of the system and method according to the disclosed technique perform the following procedures, which include determining respectively, for the at least one observed chromatographic peak, at least one parameter in a modeling function; associating respectively, for the at least one observed chromatographic peak the at least one reference chromatographic peak; and estimating respectively, for the at least one observed chromatographic peak, the measure of match according to a degree of fitness between the observed value and respective reference value of the at least one shape attribute, according to the procedure of associating. The system processor and method determine at least one parameter in a modeling function such to substantially fit the modeling function to the at least one observed chromatographic peak. The at least one parameter includes at least one shape attribute. The system processor and method associate at least one observed chromatographic peak with at least one reference chromatographic peak according to: a degree of correspondence between an observed value of the at least one shape attribute of the at least one observed chromatographic peak, and a reference value of at least one shape attribute of the at least one reference chromatographic peak; and a degree of correspondence between an observed value of the at least one temporal attribute of the at least one observed chromatographic peak, and a reference value of the at least one reference temporal attribute of the at least one reference chromatographic peak. The system processor and method estimate respectively, for the at least one observed chromatographic peak, the measure of match according to a degree of fitness between the observed value and respective reference value of the at least one shape attribute, in accordance with the association.

The terms “probability density function” and “probability distribution function” used throughout the Detailed Description, the Figures, and the Claims are interchangeable. The terms “shape attribute versus time domain”, “shape attribute versus time space” used throughout the Detailed Description, the Figures and the Claims are interchangeable. While the disclosed technique is demonstrated and elucidated by way of example through the use of a particular modeling function (e.g., a gamma distribution function, or linear combination of PDFs), its use is not intended to be limiting, as other modeling functions (e.g., polynomial modified Gaussians, Skew-normal distribution functions, etc.) may be employed. Furthermore, the disclosed technique is not limited solely to particular methodology used to determine the modeling function.

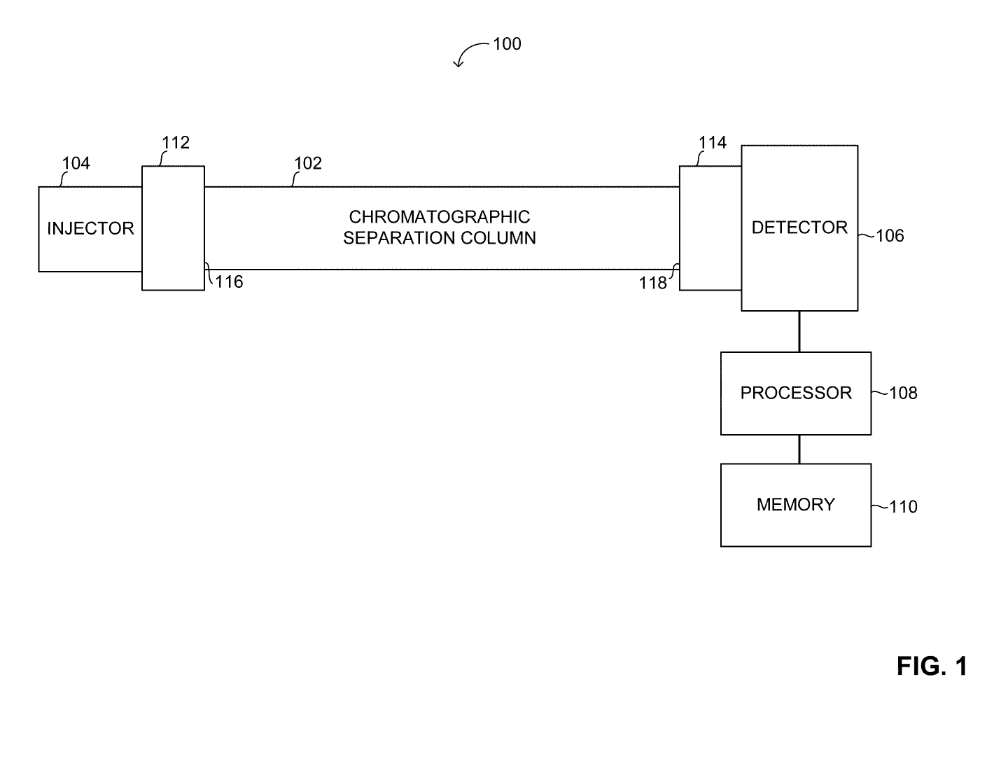

Reference is now made to FIG. 1, which is a schematic illustration of a system for analysis of gas chromatographic data, generally referenced 100, constructed and operative according to an embodiment of the disclosed technique. System 100 includes a chromatographic separation column 102, a sample delivery device 104, a detector 106, a processor 108, and a memory device 110. System 100 may optionally further include an inlet chamber 112 and an outlet chamber 114. Chromatographic separation column 102 includes an inlet 116 and an outlet 118. Sample delivery device 104 is coupled with chromatographic separation column 102 via inlet 112. Alternatively, sample delivery device 104 may be coupled with chromatographic separation column 102 via inlet chamber 112 (as shown in FIG. 1). Detector 106 is coupled with chromatographic separation column 102 at outlet 114. Alternatively, detector 106 is coupled with chromatographic separation column 102 via outlet chamber 114 (as shown in FIG. 1). Detector 106 is coupled with processor 108, which in turn is coupled with memory device 110.

Initially, a sample (not shown) to be analyzed (e.g., a breath sample) is provided into sample delivery device 104. Alternatively, the sample may initially be collected (i.e., via a sample collection device) in a sealed sorbent tube (not shown) such as a probe sampling device (PSD) and dispensed thereafter to sample delivery device 104. In the case where inlet chamber 112 is not employed, sample delivery device 104 introduces the sample, into a continuous flow of a carrier gas (not shown), such as helium, nitrogen, argon, and dried air, which sweeps the sample to inlet 116 of chromatographic separation column 102 (referred as an “on-column inlet”). Introduction of the sample to inlet 116 may be achieved automatically, such as through the use of auto-samplers and auto-injectors, which are known in the art. In the case where inlet chamber 112 is employed, it generally functions as an evaporation chamber (i.e., which is temperature-controlled) for facilitating the volatilization of the sample, typically in use with S/SL (Split/Splitless) injectors (i.e., a type of sample delivery device). Other types of sample delivery devices and techniques may be employed, for example, P/T (Purge-and-Trap) systems, gas source switching systems, SPME (Solid Phase Micro-Extraction), PTV (Programmable Temperature Vaporizing) injection, micro-syringe direct injection, thermal desorbers, and the like. For part of such implementations, system 100 may further include a carrier gas tank (not shown), for supplying the carrier gas, where other various interrelated equipment (not shown) for this purpose, such as flow controllers, valves, pressure sensors, and the like, may also be utilized.

As the sample passes through chromatographic separation column 102, various constituents (not shown) of the sample are separated by adsorption, and elute at different rates as they emerge from outlet 118 into outlet chamber 114. Outlet chamber 114 may include, for example, an eluent-jet interface, a nebulization liquid introduction system, and the like. In the nebulization liquid introduction system, an eluent-gas mixture is nebulized (i.e., as an aerosol) and sprayed directly into detector 106 or alternatively, into part of outlet chamber 114, thus creating an aerosol having improved uniformity. By employing eluent-jet or nebulization liquid introduction systems, for example, packed capillary columns, may be interfaced directly to detectors which are based on flame ionization, flameless thermionic ionization, photometric type detectors, and the like. Chromatographic separation column 102 is preferably a capillary type column, generally affording a relatively higher sensitivity than those of packed column types (i.e., since overall, the detected chromatographic peaks are higher and much sharper, thereby yielding better signal-to-noise ratio). The disclosed technique, however, is not limited to a particular type of chromatographic column, as other types of columns may be utilized (e.g., packed columns, internally heated microFAST columns, micro-packed columns). Since molecular adsorption and the rate at which the sample progresses through chromatographic separation column 102 are temperature-dependent, it is usually necessary to control the temperature of chromatographic separation column 102. For such a purpose, an oven (not shown) is usually employed to house and maintain chromatographic separation column 102 at a desired temperature. The temperature of the oven is electronically controlled to typically hold chromatographic separation column 102 at particular isothermal conditions for each analysis that is performed.

When the eluates (i.e., effluents) emerge from chromatographic separation column 102, at least a fraction of the constituents that composed the sample are detected by detector 106 (arranged to be in communication with outlet 118). Many types of detectors may be used in GC. GC detectors may be classified according to their selectivity (i.e., a measure of the ability of a detector to respond, in relative terms, to a particular element or compound versus other elements or compounds), and other factors, such as whether they are concentration dependant detectors or mass flow detectors, etc. Selective detectors, for example, respond to a diversity of compounds having a mutual chemical or physical property, whereas non-selective (universal) detectors respond to substantially all compounds apart from the carrier gas. The various types of detectors that may be employed by the disclosed technique, include flame ionization detectors (FID), thermal conductivity detectors (TCD), electron capture detectors (ECD), nitrogen phosphorus detectors, flame photometric detectors (FPD), photo-ionization detectors (PID), Hall electrolytic conductivity detectors, discharge ionization detectors (DID), pulsed discharge ionization detectors (PDD), mass selective detectors (MSD), helium ionization detectors (HID), thermal energy (conductivity) analyzer/detectors (TEA/TCD), and the like. The TCD is an example of a concentration dependant detector having universal selectivity. The FPD is an example of a selective detector of mass flow type, whose selectivity is toward phosphorous, tin, germanium, sulfur, selenium, etc. Detector 106 typically produces an electrical signal, s(t) in response to the detected concentration of the constituents in the sample as a function of time. This electrical signal is transferred to processor 108 for processing and analysis. Alternatively, system 100 may further include an amplification stage (not shown), operational between detector 106 and processor 108, for amplifying the electrical signal produced by detector 106. The amplification stage may be implemented by preamplifiers, amplifiers, electrometric amplifiers (EMA), and the like.

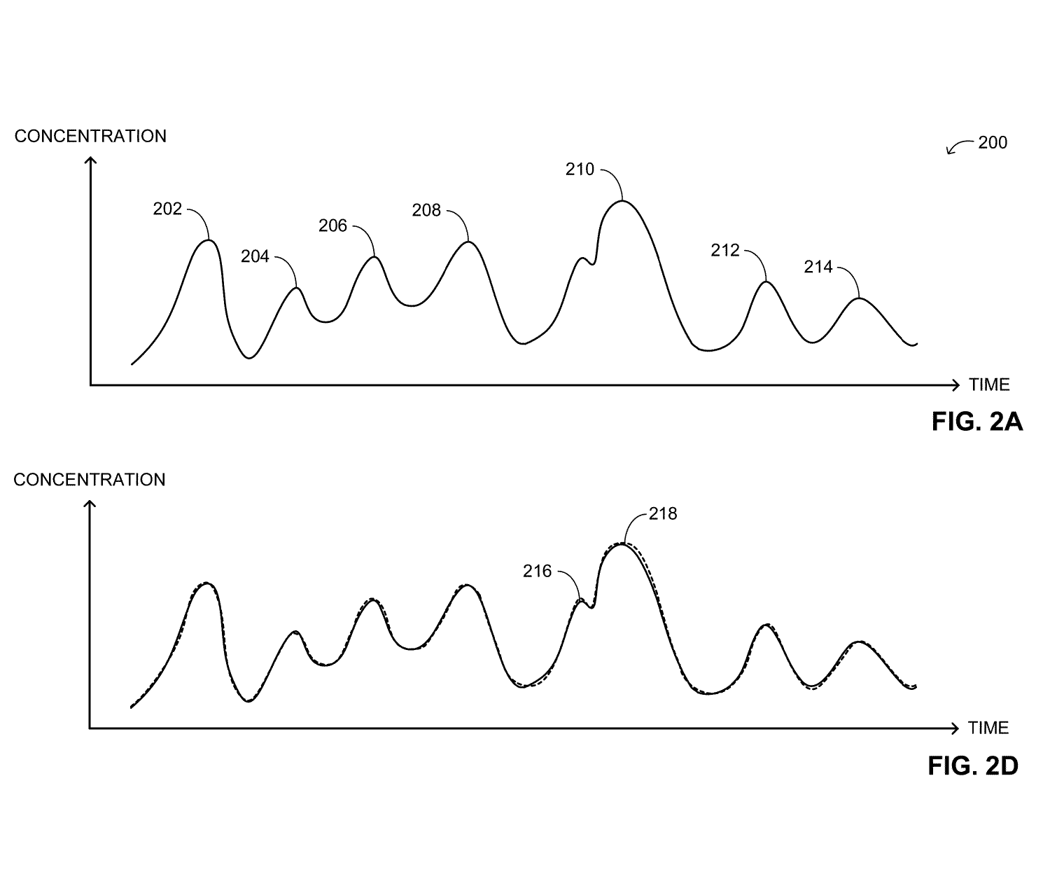

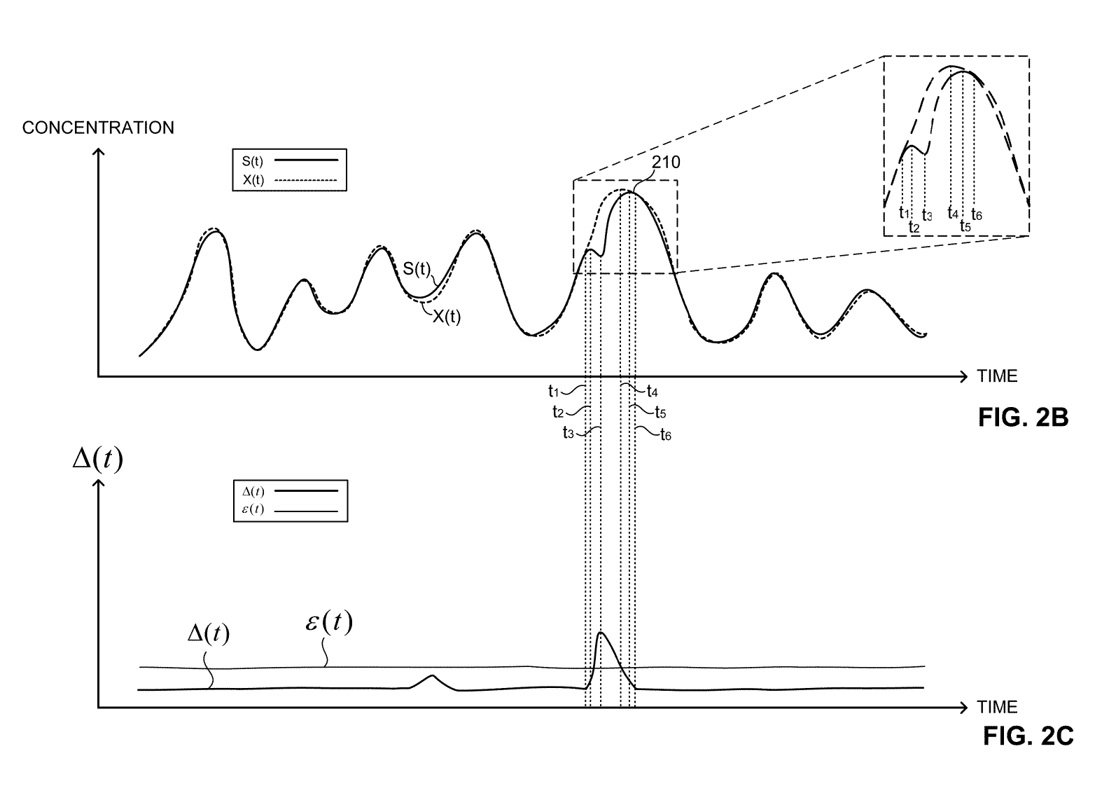

The electrical signal is a representation of chromatographic data (not shown), which processor 108 transfers to memory device 110 for storage and retrieval. The chromatographic data respective of each electrical signal that is analyzed by processor 108 may be arranged and presented in the form of a chromatogram. Reference is now further made to FIGS. 2A and 2B. FIG. 2A is a schematic illustration of a representative chromatogram, generally referenced 200, acquired by the system illustrated in FIG. 1. FIG. 2B is a schematic illustration of a graph of an initial estimate of a time-dependent modeling function, modeled according to the chromatogram of FIG. 2A. Chromatogram 200 represents a graphical record of the chromatographic separation of a particular sample, presented in a Cartesian coordinate system, the vertical axis of which represents a measure of concentration of detected eluted materials (i.e., the detector response), as a function of time (horizontal axis). Chromatogram 200 includes a plurality of chromatographic peaks 202, 204, 206, 208, 210, 212 and 214 each of which represents a particular component or a combination of different merged components (i.e., not separated by GC). Detected electrical signal s(t) can be normalized in order to account (e.g., compensate) for the presence of disproportionate concentrations of constituents composing a given sample, which for example, may be due to external influences such as from other chemicals or from the specific pre-selectivity of the detector that is employed.

Memory device 110 stores a database (not shown) of a plurality of reference GC data corresponding to known chemical compositions. Particularly, the database stores data corresponding to a set D′ of peaks, where each element in this set represents a chromatographic peak of a known chemical composition, associated with a particular adverse medical condition (e.g., disease, infection). Data corresponding to single or combination of chemical compositions, within the database, may be grouped to define a biomarker (not shown). For example the subset {d_{8′}, d_{34′}, d_{371′}}⊂D′ may define a biomarker of a particular disease. A biomarker generally refers to a component (or a plurality of components) whose qualitative and quantitative presence or absence in chromatographic data of a sample is an indicator of a particular biological state of a biological being (e.g., human, dog, cat). The database further stores a set M′ of biomarkers, where each biomarker element is defined as a subset of D′. The primed indices herein denote reference data. In view of the aforementioned example, a biomarker m_{1′}⊂M′ may be defined as m_{1′}={d_{8′}, d_{34′}, d_{371′}}. Likewise, the database stores data corresponding to a set H′ of peaks, where each element in this set represents a chromatographic peak of a chemical composition that is either unknown to be associated with a particular adverse medical condition (e.g., typically appearing in healthy individuals), or that it is known to be associated with a particular adverse medical condition, but nonetheless, is not of interest for detection.

The database is initially constructed at a learning and calibration stage. In this stage, chromatographic data (i.e., chromatograms) from a plurality of known and possibly unknown chemical compositions is acquired, wherefrom it will ultimately constitute as reference chromatographic data. In particular, chromatographic data (e.g., peaks) from a plurality of VOCs is acquired (e.g., via a breath sample) from individuals diagnosed with a particular medical condition of interest (i.e., in detection) and compared with a plurality of VOCs acquired from individuals diagnosed as not having that particular medical condition of interest in order to identify chromatographic data that characterizes the medical condition of interest (i.e., biomarkers). Mass spectrometry (MS) as well as spectroscopy techniques may be employed in this stage as a method of calibration, where the elemental composition of each sample that is collected is compared and associated with the respective retention time of each component in the sample. Generally, chromatographic data of VOCs from both “healthy” and “unhealthy” individuals are collected, analyzed, and stored in the database. Analysis of the chromatographic reference data may be performed by the detection of chromatographic peaks by, for example, principal component analysis (PCA), and the like. Each detected chromatographic peak may be modeled by a particular probability density function, according to the methods which will be described in greater detail herein below.

The disclosed technique resolves and identifies components within overlapping chromatographic peaks whose different constituents compose a given sample, by employing a modeling function defined as a linear combination of probability density functions (also referred to as probability distribution functions), Vᵢ having the general form:

$${\sum }_{i} {α}_{i} {V}_{i} \qquad ( 1 )$$

where αᵢ are the coefficients of the probability density functions, and i is a positive integer. In particular, it is assumed, according to the disclosed technique that the linear combination of probability density functions in expression (1) may be decomposed into a linear combination of probability density functions, having the form:

$$x ( t ) = {\sum }_{j} {β}_{j} {D}_{j} ( t ) + {\sum }_{k} {η}_{k} {H}_{k} ( t ) + {\sum }_{l} {δ}_{l} {O}_{l} ( t ) + {\sum }_{m} {ι}_{m} {I}_{m} ( t ) \qquad ( 2 )$$

where x(t) represents the time-dependent modeling function utilized to model the electrical signal s(t), acquired by detector 106. It is noted that electrical signal s(t) might have undergone modification (e.g., amplification, preprocessing). Dⱼ(t) represents the j th time-dependent probability density function that models a respective chromatographic peak (i.e., that is substantially unresolved) having a likelihood of corresponding to a particular chromatographic peak in set D′ (i.e., associated with a particular adverse medical condition). Each of the k time-dependent probability density functions Hₖ(t) model a chromatographic peak (i.e., that is in general, partially resolved) having a likelihood of corresponding to a particular chromatographic peak in set H′ (i.e., that is either unknown to be associated with a particular medical condition, or that is known to be associated with a particular medical condition, but nonetheless is not of interest for detection). Isolated chromatographic peaks (i.e., those which are generally resolved), whether they are known or unknown to be associated with a particular medical condition are modeled by m th time-dependent probability density function Iₘ(t)(i.e., have a likelihood of corresponding to a particular chromatographic peak either in set H′ or D′). Oₗ(t) represents the 7th time-dependent probability density function that respectively models unknown chromatographic peaks (i.e., unclassifiable chromatographic data that is not part of the database) or remainder terms resulting from the modeling procedure. The scalar weights, βⱼ, ηₖ, and tₘ are coefficients in the linear combinations with each of the respective probability density functions Dⱼ(t), Hₖ(t), Oₗ(t), and Iₘ(t). Indices j, k, l, and m are positive integers.

A variety of probability density functions may be used for Dⱼ(t), Hₖ(t), O₁(t), and Iₘ(t), such as EMGs, gamma distribution (i.e., the probability density function thereof), polynomial modified Gaussians, Skew-normal distribution, Chi distribution, Poisson distribution, Maxwell-Boltzmann distribution of normalized molecular speeds (i.e., the Chi distribution with three degrees of freedom (DOF)), Maxwell-Bolzmann distribution modified for retention times, Rayleigh distribution (i.e., the Chi distribution with two DOF and a standard deviation, σ=1), and the like.

The modeling process may initially model isolated chromatographic peaks (i.e., peaks 202 and 212), which appear in chromatogram 200. For these peaks and generally, for each peak in that is suspected to be an isolated peak, processor 108 finds a respective time-dependent probability density function Iₘ(t), which will serve as a mathematical model for that peak. A particular parametric family of time-dependent probability density functions that may be used is the gamma probability density function, parameterized in terms of a shape parameters ζ≧0, (κε [symbol] ) and a scale parameters θ≧0 (θε [symbol] ), having the general form:

$$ι ( t ; ζ , θ ) = {t}^{κ - 1} \frac{{e}^{- t / θ}}{{θ}^{κ} Γ ( ζ )} \qquad ( 3 )$$

where t≦0, and Γ(κ) is the gamma function, given by:

$$Γ ( ζ ) = {{\int }_{0}}^{∞} {y}^{ζ - 1} {e}^{- y} d y . \qquad ( 4 )$$

Concurrently, the modeling process employs the gamma probability density function to model other peaks, which appear in chromatogram 200 (i.e., peaks 204, 206, 210, 212 and 214). By comparing the mode position of each peak (e.g., maximum peak height thereof) along the time axis with data corresponding to the positions of reference chromatographic peaks in sets D′ and H′, stored in memory device 110, processor 108 estimates the likelihood of match between each of the peaks in chromatogram 200 and the respective reference chromatographic peaks. Peaks in chromatogram 200, which substantially match reference chromatographic peaks, in this manner, are classified according to their type. Consequently, each chromatographic peak is classified as being either an isolated peak, an unknown peak, or one which substantially matches corresponding reference chromatographic peaks in either sets D′, H′, stored in the database. For example, processor 108 estimates that peaks 204 and 208 substantially match respective reference chromatographic peaks d₁ and d₂ in set D′, that peak 206 substantially matches reference chromatographic peak h₁ in set H′, and that peaks 210 and 214 are to be classified as unknown. At least in a preliminary phase in the modeling process, those chromatographic peaks, which are classified as unknown, do not substantially correspond to reference chromatographic peaks in sets D′ and H′. Once a previously unidentifiable chromatographic peak is identified, it may be reclassified accordingly. For the purpose of elucidating the disclosed technique, it is supposed that peak 210 is composite (i.e., consisting of at least two components, which overlap to a certain degree). Processor 108, without a priori knowledge, initially classifies peak 210 as an unknown peak, which is to be modeled, accordingly, by the probability density functions Oₗ(t). It is noted that a chromatographic peak classified as an isolated peak, may also correspond to a reference chromatographic peak in sets D′ or H′. In this case, these isolated peaks are modeled according to the time-dependent probability density function Iₘ(t) for isolated peaks, mentioned above. For example, peak 212 is classified and modeled as an isolated peak, although this peak is attributable to a reference chromatographic peak in set H′. Thus, each of the classified chromatographic peaks is modeled according to its respective probability density function (i.e., Dⱼ(t), Hₖ(t), O₁(t), and Iₘ(t)).

Processor 108 may employ registration procedures to facilitate classification of the chromatographic peaks according to chromatographic peak type (e.g., according to temporal attributes of each chromatographic peak). Particularly, processor 108 registers chromatographic peaks in the chromatographic data of detected electrical signal, s(t) with the reference chromatographic peaks that are stored in the database, by comparing the retention time values of the chromatographic peaks with corresponding reference retention time values of the reference chromatographic peaks. Processor 108 may compare the mode (or mean) position in the time domain (i.e., along the time axis) of each chromatographic peak with data corresponding to the positions of reference chromatographic peaks stored in memory device 110. Registration involves employment of a monotonic transformation function ƒ(t) such that s(ƒ(t)) is matched to a database entry r(t). Preferably, the transformation function is linear (i.e., ƒ(t)=a·t+b, where a and b are parameters), however, the transformation function may also be non-linear. The transformation function is chosen so that a matching score (i.e., yielded from matching s(ƒ(t)) with corresponding r(t)'s) is maximal within predefined ranges for a and b. This may be achieved by employing exhaustive search techniques, or preferably by using an optimization procedure such as the Gauss-Newton method. Alternatively, the transformation function is chosen in the manner that takes into account chromatographic peaks that recurrently appear (e.g., that of 2-methyl-undecane). Further alternatively, registration involves insertion (via inlet 112) of specific chemicals (i.e., by adding, mixing with the sample to be analyzed) whose retention times are known so as to produce known chromatographic peaks having respectively known retention times. The transformation function is constructed so as to account for these known chromatographic peaks in order to facilitate registration.

Chromatographic peaks registered in the time domain with corresponding reference chromatographic peaks are classified according to their type (e.g., isolated chromatographic peaks, those substantially matching reference chromatographic peaks, unknown chromatographic peaks). The gamma probability density function that models each of the classified chromatographic peaks is characterized by the location of the peak with respect to the time axis (e.g., the mean, μ=ζθ), ζ, and θ. Processor 108 initially guesstimates these parameters for each probability density function that is used to model a chromatographic peak. For example, chromatographic peaks classified as those substantially corresponding to reference chromatographic peaks in set D′, are modeled by probability density functions Dⱼ(t; ξⱼ, θⱼ). To optimize the initial guesstimate, processor 108 employs optimization techniques, such as the method of steepest descent (i.e., gradient descent) to search for improved solutions of the parameters in each of the probability density functions (i.e., the evaluation functions) that model chromatographic peaks in chromatogram 200. Utilizing the weighted average around the peak location substantially ensures that the probability density functions are sufficiently smooth at the initial guesstimate solution, at least in a neighborhood thereof, as well as the existence of the directional derivative for probability density functions. By defining for each probability density function a parameter vector p as a column vector of a preset number of real-valued parameters p=(μ, ζ, θ), a new solution is generated according to the following iterative rule:

pᵣ₊₁=pᵣ−sᵣ∇pdf(pᵣ) (5)

where “pdf” denotes the probability density function, r≧1, ∇pdf(pᵣ) is the gradient of a particular density function at pᵣ, and sᵣ is a chosen step size parameter. According to this method, the parameter vector p is adjusted (i.e., perturbed) by small amounts in the direction that would most likely reduce evaluations of candidate solutions to the moment parameters in each of the probability density functions. Generally, since each iteration reduces the model error, iterative solutions generated by gradient descent method converge to substantially optimal values p₀=(μ₀, ζ₀, θ₀). It is noted that in cases where solutions generated by the gradient descent method become caught in local minima, the disclosed technique may employ simulated annealing techniques, and the like. Alternatively, parameter vector p may be defined as a column vector of the first four moments of the gamma distribution function (i.e., or other distribution function for that matter) such that p=(μ, var, γ, κ), where the mean, variance, skewness, and kurtosis (specifically, the excess kurtosis) are given respectively by μ=ζθ, var=ζθ², γ=2\sqrt{ζ}, and κ=6ζ. Typically, one of the moments (e.g., the kurtosis) is fixed to an initial guesstimate value, while the gradient descent optimization procedure proceeds in finding candidate solutions for the other moments in the evaluation function. A qualitative measure of the goodness of a result p₀=(μ₀, var₀, γ₀), obtained from the gradient descent optimization procedure, may be substantially verified by comparing the calculated value for the kurtosis with the value of the kurtosis extrapolated from the values obtained from the optimization procedure. Alternatively, the disclosed technique may employ other optimization methods, such as the method of Newton, Quasi-Newton methods, the Gauss-Newton method, the Levenberg-Marquardt algorithm (LMA), and the like. For example, in the method of Newton, the convergence toward a local minimum is considerably faster than that of gradient descent, however, it is required to calculate the inverse of the Hessian matrix of the probability distribution functions, which may occasionally be problematical (e.g., ill-defined).

The candidate parameters to the probability density functions, yielded from the gradient descent optimization procedure are employed to characterize the modeling function. A least square method is employed to fit the modeling function to the experimental data, that of electrical signal s(t). In particular, a sum S of the square of the differences between the time-dependent modeling function and an arbitrary integer number (e.g., n>0) of respective points in detected electrical signal s(t) is to be minimized:

$$S = {\sum }_{i = 1}^{n} {( {s}_{i} ( t ) - {x}_{i} ( t ) )}^{2} \qquad ( 6 )$$

Processor 108 determines by the least square method the linear coefficient parameters (i.e., the scalar weights) βⱼ, ηₖ, δₗ and ιₘ from n equations, as there may be more equations than unknowns. A first estimate of the modeling function is defined once the linear coefficient parameters are substantially known. A graph of an initial estimate of the time-dependent modeling function x(t) is illustrated in FIG. 2B. To obtain a possibly improved estimate of the modeling function, the gradient descent method is applied once more, in accordance with equation (5), to optimize the values of the parameters (e.g., μ, ζ, θ) of the probability density functions, where small perturbations to these parameters are introduced. Previously computed parameter values p₀=(μ₀, ζ₀, θ₀) for each of the probability density functions are used as the respective candidate guesses for suggested local minima.

A quantitative assessment as to the model error is calculated (via processor 108) by taking the difference between the observed data (i.e., the electrical signal) and the modeling function, specifically:

Δ=x(t)−s(t) (7)

Alternatively, the model error may be defined as a time-dependent model error function Δ(t)=x(t)−s(t). A (global) model error threshold parameter is defined, ε, for if Δ>ε it is said that the modeling function inadequately fits the observed data. Generally, the model error threshold parameter may be a time-dependent function ε(t), such that for every time value that satisfies the inequality Δ(t)>ε(t), it is said that the modeling function inadequately fits the observed data at that time value. In this case, it is hypothesized that the model error Δ is due to unresolved components (e.g., chromatographic peaks, noise) such as in the situation of unresolved overlapping peaks (e.g., peak 210). To further explicate the relationship between the exhibited model error and unresolved chromatographic peaks, reference is now further made to FIG. 2C. Specifically, FIG. 2C is a schematic illustration of a graph of the calculated time-dependent model error resulting from the initially estimated modeling function of FIG. 2B, plotted in conjunction with a graph of a time-dependent model error threshold function. FIG. 2C illustrates that the greatest model error occurs between t₂ and t₄, specifically at t₃, which corresponds to the temporal neighborhood of peak 210. Given, that the model error in that neighborhood exceeds the values for the time-dependent model error threshold parameter, it is therefore suspected that peak 210 is composite. This model error may be caused, therefore, by unresolved or concealed chromatographic peaks, which were unidentified and unaccounted for in the initially estimated modeling function. Analysis of the temporal neighborhood of peak 210 indicates that the model error is substantially negligible at t₁ and t₆, and that the maximum value of the modeling function for peak 210 occurs at t₄. To estimate the number of peaks concealed within a suspected composite peak, processor 108 may analyze the curvature of the time-dependent model error (function), such as for example, information contained in the second derivative thereof (e.g., points of inflection). Peak 210, which was in effect modeled as a single peak (e.g., by a probability density function O_{t̅}(t)) in the initially estimated modeling function is now suspected as being composite (i.e., containing a plurality of peaks) and remodeled using a plurality q of probability density functions

$$( e . g . , {\sum }_{q} {O}_{q} ( t ) ) ,$$

by taking into account the residuum model error. A refined time-dependent modeling function x₂(t) is defined by incorporating a remodeled expression for peak 210 (i.e., or generally other peaks for that matter) suspected of being composite:

$${x}_{2} ( t ) = {\sum }_{j} {β}_{j} {D}_{j} ( t ) + {\sum }_{k} {η}_{k} {H}_{k} ( t ) + [ {\sum }_{l , l \neq \tilde{l}} {δ}_{l} {O}_{l} ( t ) + {\sum }_{q} {δ}_{q} {O}_{q} ( t ) ] + {\sum }_{m} {ι}_{m} {I}_{m} ( t ) \qquad ( 8 )$$

Now the refined time-dependent modeling function is taken as the current modeling function, and the modeling process is repeated by taking successively refined modeling functions x₃, x₄, x₅ . . . until the model error in equation (7) is minimized. A test for the hypothesis that peak 210 is composite may be substantially supported by the indication of whether the model error is gradually reduced and converges to a minimum, by using successively refined time-dependent modeling functions in each iteration in the modeling process. If in fact the modeling error is reduced to a minimum by employing a specific number (e.g., two) of probability density functions to model peak 210, it serves to an extent, an indication that peak 210 is composite, and that it is composed from that specific number overlapping peaks. Each of the peaks from which peak 210 is identified to be composed from is modeled by a respective probability density function. For illustrative purposes, reference is now further made to FIG. 2D, which is a schematic illustration of a refined estimate of the time-dependent modeling function of FIG. 2B, modeled according to the chromatogram of FIG. 2A. In the example given, peak 210 (FIG. 2B) is resolved into two distinct peaks 216 and 218 (FIG. 2D), their maxima occurring respectively at t₂ and t₅ (FIGS. 2B and 2C), which were unidentified at the onset of the modeling process. At this point, if these resolved peaks substantially match reference peaks when compared to the database (i.e., in either of sets D′ and H′), in subsequent modeling functions, these peaks will be reclassified and remodeled according to their respectively determined classification. A statistical distance measure (i.e., statistical divergence) such as the Kullback-Leibler divergence (i.e., information divergence) for gamma probability distribution functions may be employed as a test for determining a measure of match or alternatively, a measure of difference between reference peaks stored in the database and newly identified resolved peaks, suspected to correspond to the respective reference peaks, given by the following equation (9):

$${D}_{KL} ( {ρ}_{R} , {σ}_{R} \vert \vert ρ , σ ) = log ( \frac{Γ ( ρ ) {σ}_{R}^{{ρ}_{R}}}{Γ ( {ρ}_{R} ) {σ}^{R}} ) + ( {ρ}_{R} - ρ ) [ ψ ( {ρ}_{R} ) - log {σ}_{R} ] + {ρ}_{R} \frac{σ - {σ}_{R}}{{σ}_{R}} \qquad ( 9 )$$

where Γ(ρ_{R},σ_{R}) is the gamma probability density function associated with reference (R) chromatographic data (i.e., of a particular reference chromatographic peak, stored in the database), Γ(ρ,σ) is the gamma probability density function, which is to be tested (e.g., corresponding to a newly resolved chromatographic peak), and ψ(ρ_{R}) is the digamma function. The parameter ρ equals the shape parameter ζ, and σ is the rate parameter (i.e., defined as the inverse scale parameter: σ=1/θ), where the subscript “R” denotes parameters of reference data. A minimal value returned by the Kullback-Leibler divergence indicates the best attained match for a particular pair of probability distribution functions, namely, a reference stored in the database and one which is tested in suspicion of substantially matching the reference. Alternatively, the Kullback-Leibler divergence may be utilized to test the measure of difference between other pairs of reference and observed chromatographic peaks. Thus, the Kullback-Leibler divergence may be employed to test the measure of difference between a multi-marker (a plurality of markers) in the database and a plurality of respective peaks of a given sample (e.g., such as in a multi-comparison test). Generally, given a library (i.e., a database) of multi-markers, the markers with the maximal information divergence are the most probable of being detected. Further alternatively, other statistical distance measures for evaluating the intersection between distributions (i.e., of peaks) can be employed instead of the Kullback-Leibler divergence criterion.

Once the model error is minimized, the modeling process terminates, and the refined modeling function is substantially determined, with a substantially reasonable level of repeatability. Each of the determined coefficients δⱼ, ηₖ, δₗ and ιₘ in the refined modeling function represents a weighted term for its respective probability density function, which in turn models a respective chromatographic peak. In other words, each coefficient represents the relative value of the detected concentration for a particular chemical in the sample. Typically, to account for the presence of disproportionate concentrations of components in a given sample, the coefficients in equation (8) are normalized by evaluating a measure of statistical dispersion, such as the interquartile range (IQR). The IQR, defined as the difference between the third and first quartiles (Q3−Q1), is calculated and used to normalize each of the detected peaks (i.e., the maximum value of each peak (corresponding to its respective detected maximum concentration) is divided by the IQR).

Nevertheless, certain chemical compounds whose detected concentrations may be below a predefined value such that they may be insignificant, statistically. For example, low detected concentrations of a particular chemical, which defines a certain biomarker, may be an indication to the absence of a particular disease to which this biomarker is attributed to. Therefore, for each of the coefficients in equation (8) there is defined a respective threshold parameter (not shown) that sets a minimum value, for if it is exceeded, the probability density function corresponding to that coefficient is considered as significant. Consequently, if one of the resolved peaks, for example, corresponds to a chemical compound required for the identification of a particular biomarker that was previously undetected due to overlapping peak phenomenon, it may now be detected. It is noted that system 100 can generate an indication (not shown) in the case where a particular sample cannot be analyzed (e.g., a failure to model).

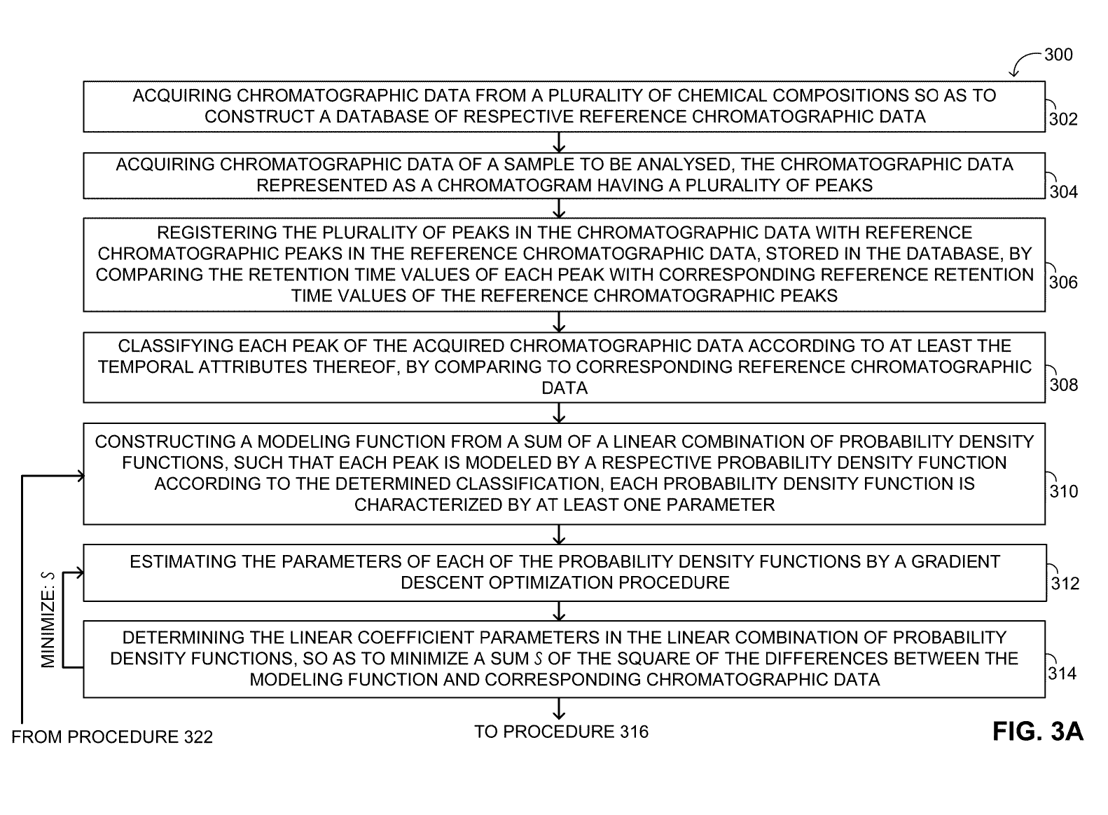

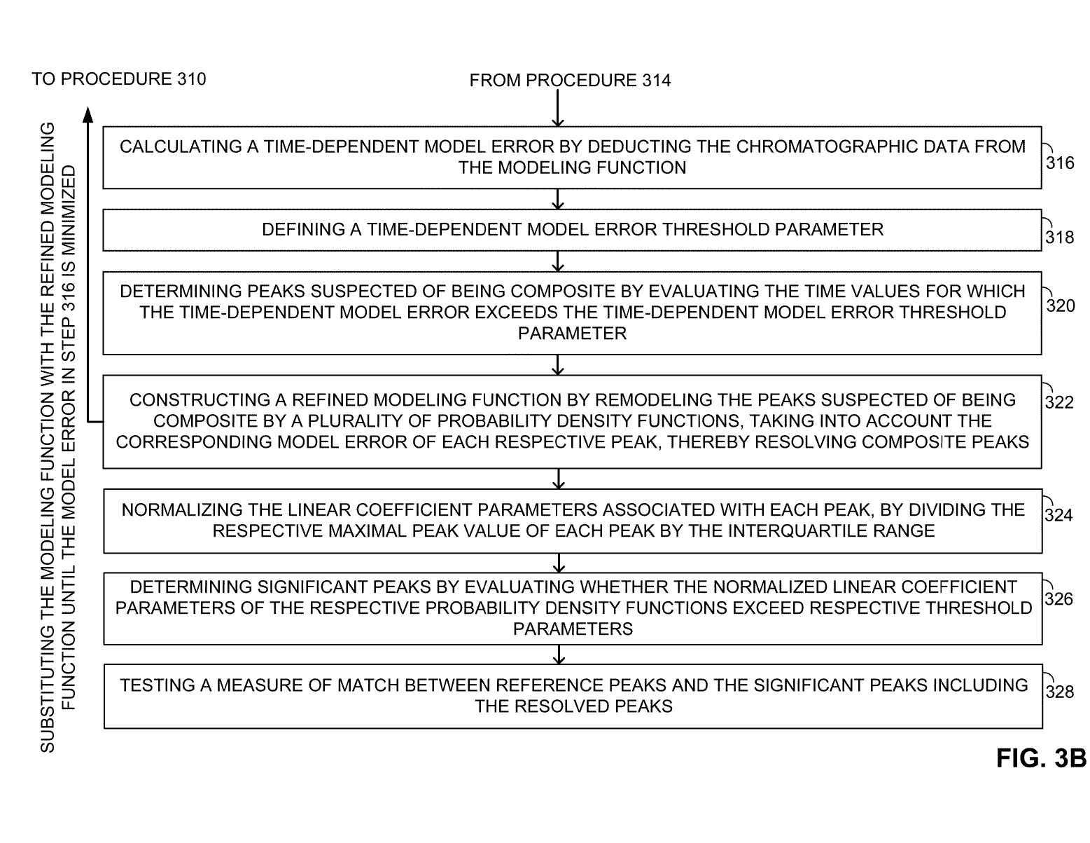

Reference is now made to FIGS. 3A and 3B. FIG. 3A is a schematic block diagram illustrating the method for resolving and identifying components within overlapping chromatographic peaks whose different constituents compose a given sample, generally referenced 300, constructed and operative according to the embodiment of the disclosed technique. FIG. 3B is a schematic block diagram illustrating a continuation of the method from FIG. 3A. In procedure 302, chromatographic data from a plurality of chemical compositions are acquired, so as to construct a database of respective reference chromatographic data. With reference to FIG. 1, system 100 acquires, via detector 106 chromatographic data from a plurality of chemical compositions (not shown) so as to construct a database of respective reference chromatographic data to be stored in memory 110.

In procedure 304, chromatographic data of a sample to be analyzed is acquired, where the chromatographic data is represented as a chromatogram having a plurality of peaks. With reference to FIGS. 1 and 2A, system 100 (FIG. 1) acquires via detector 106 chromatographic data of a sample to be analyzed. The acquired chromatographic data of the sample is represented as chromatogram 200 (FIG. 2A) having a plurality of chromatographic peaks 202, 204, 206, 208, 210, 212 and 214.

In procedure 306, the plurality of peaks in the chromatographic data are registered with reference chromatographic peaks in the reference chromatographic data, stored in the database, by comparing the retention time values of each chromatographic peak with corresponding reference retention time values of the reference chromatographic peaks.

In procedure 308, each peak of the acquired chromatographic data is classified according to at least the temporal attributes thereof, by comparing to corresponding reference chromatographic data.

In procedure 310, a modeling function form a sum of a linear combination of probability density functions is constructed, such that each peak is modeled by a respective probability density function according to the determined classification, where each probability density function is characterized by at least one parameter. With reference to equation (2), the modeling function x(t) is modeled with the plurality of probability density functions Dⱼ(t), H(t), Oₗ(t), and Iₘ(t).

In procedure 312, the parameters of each of the probability density functions are estimated by a gradient descent optimization procedure. With reference to equation (5), the column vector p of a preset number of real-valued parameters p=(μ, ζ, θ) of each of the probability density functions are estimated.

In procedure 314, the linear coefficient parameters in the linear combination of probability density functions are determined, so as to minimize a sum s of the square of the differences between the modeling function and corresponding chromatographic data. With reference to equation (6), the linear coefficient parameters βⱼ, ηₖ, δₗ and ιₙ are determined, so as to minimize the sum s defined in equation (6). The parameters of each of the probability density functions are estimated again in procedure 312 by the gradient descent optimization method. Procedures 312 and 314 are looped (i.e., may be iterated over several times) until the sum s is minimized.

In procedure 316, a time-dependent model error is calculated by deducting the chromatographic data from the modeling function. With reference to FIG. 2C and equation (7), the model error is calculated by taking the difference between the observed data (i.e., the electrical signal) and the modeling function.

In procedure 318, a time-dependent model error threshold parameter is defined. This parameter may be defined as a time-dependent function. With reference to FIG. 2C, the time-dependent model error threshold parameter, ε is plotted.

In procedure 320, peaks suspected of being composite are determined by evaluating the time values for which the time-dependent model error exceeds the time-dependent model error threshold parameter. With reference to FIGS. 2A and 2C, the time-dependent model error temporally corresponding to peak 210, substantially exceeds the model error threshold parameter between the time values of t₂ and t₅.

In procedure 322, a refined modeling function is constructed by remodeling the peaks suspected of being composite by a plurality of probability density functions, taking into account the corresponding model error of each respective peak, thereby resolving composite peaks. Successively refined modeling functions are substituted iteratively with the modeling function in procedure 310 until the model error in procedure 316 is minimized. With reference to FIG. 2A and equation (8), peak 210 is suspected as being composite and is remodeled by a plurality of probability density functions so as to define a refined time-dependent modeling function, which is taken as the current modeling function in equation (2), and the modeling process is repeated iteratively (i.e., from step 310) by taking successively refined modeling functions, until the model error in equation (7) is minimized.

In procedure 324 the linear coefficient parameters associated with the peak is normalized, by dividing the respective maximal peak value of each peak by the IQR. With reference to equation (8), the linear coefficient parameters βⱼ, ηₖ, δₗ and ιₙ are normalized, by the calculated IQR.

In procedure 326, significant peaks are determined by evaluating whether the normalized linear coefficient parameters of the respective probability density functions exceed respective threshold parameters. With reference to equation (8), the significant peaks (not shown) are determined by evaluating whether the linear coefficient parameters βⱼ, ηₖ, δₗ and ιₙ exceed respective threshold parameters (not shown).

In procedure 328 a measure of match between reference peaks and the plurality of peaks including the resolved peaks are tested. With reference to FIGS. 1 and 2D as well as equation (9), resolved peaks 216 and 218 are tested with the Kullback-Leibler divergence to test a measure of match (or measure of difference) between them and chromatographic reference peaks stored in the database of memory 110 (FIG. 1).

According to another embodiment of the disclosed technique, there is thus provided another method and system for probabilistically determining whether a chemical sample, acquired from a biological entity (e.g., human, animal) is associated with at least one biomarker that is indicative of either one of: a healthy medical condition, an adverse medical condition (e.g., cancer), and an indeterminate medical condition. In general, the system and method of the disclosed technique employ self-reliant (i.e., stand-alone) gas chromatography (GC), which means that only GC is used, in contrast to gas chromatography-mass spectroscopy (GC-MS) employed in prior art techniques. The self-reliant GC method and system of the disclosed technique do not necessitate use of either MS techniques or MS instruments that are employed in known GC-MS combined systems. Such systems that rely on both GC and MS are generally more cumbersome, expensive, complex, and require more maintenance, as well as being less portable.

In particular, according to the present embodiment of the disclosed technique, the representation and analysis of chromatographic data is performed in a domain which is different to that employed in conventional GC analysis. In conventional GC analysis, chromatographic data is typically represented in the form of chromatograms that record the concentration of eluted materials (i.e., the detector response) as a function of time (e.g., retention time), hence in the concentration versus retention time domain. In the present embodiment, chromatographic data is represented and analyzed in terms of various shape attributes of the probability distribution functions (PDFs) that respectively model chromatographic peaks as a function of time, hence in the PDF shape attribute versus time domain. A shape attribute of a PDF is defined herein as an attribute or feature that may be used to characterize a PDF, such as one of its shape parameters, its scale parameter, its maximum value, its mean value, its variance, its kurtosis, and the like. Since chromatographic peaks exhibit varying characterizing shapes in time or characteristic “propagating spreads” in time, they have characteristic distributions that may be mathematically modeled by PDFs and their shape parameters. The disclosed technique thus offers to represent and analyze chromatographic data in the chromatographic-peak-characterizing-shape versus time domain.

The system and method of the present embodiment is operative to construct a database of reference chromatographic data, acquired from a plurality of compounds, where each compound is acquired from a source (e.g., an individual, a patient, a subject, etc.) that is known to be associated with either a healthy medical condition or an adverse medical condition. In other words, the database is constructed from information pertaining to a plurality of chemical samples (e.g., VOCs) that are acquired from two distinct sources or individuals who are verified to have a particular adverse medical condition vis-à-vis those individuals verified not to have that particular adverse medical condition (i.e., a healthy medical condition in that respect). Thus, it may be possible to associate various VOCs with biomarkers that are indicative to either the presence or absence of a particular medical condition. Alternatively, the database may be constructed (i.e., at least partially) from the injection of known substances (i.e., into chromatographic system 100), whose identity is known to be associated with at least one biomarker that is indicative of an adverse medical condition (i.e., in a biological entity). The database of reference chromatographic data includes a plurality of reference chromatographic peaks, each characterized by at least one temporal attribute and at least one shape attribute. Consequently, samples acquired and analyzed by the GC system may then be used to further build the database of reference chromatographic data.

For each sample analyzed, the GC system produces a spectrum of observed chromatographic peaks corresponding to the analytes present in the sample eluting from the GC column. Consequently, each observed chromatographic peak that represents a particular compound (i.e., having distinctly resolved components or a combination of unresolved components having similar retention times) may be characterized by shape attributes and by at least one temporal attribute (e.g., retention time). The system and method determine for each observed chromatographic peak at least one parameter in a modeling function, such to substantially fit the modeling function to at the at least one observed chromatographic peak. At least one of these parameters is at least one shape attribute (e.g., a PDF shape parameter). The modeling function is defined as a sum of a linear combination of probability distribution functions, as defined in equation (2). The system according to the present embodiment is identical, in terms of hardware, to system 100 (FIG. 1) of the preceding embodiment.

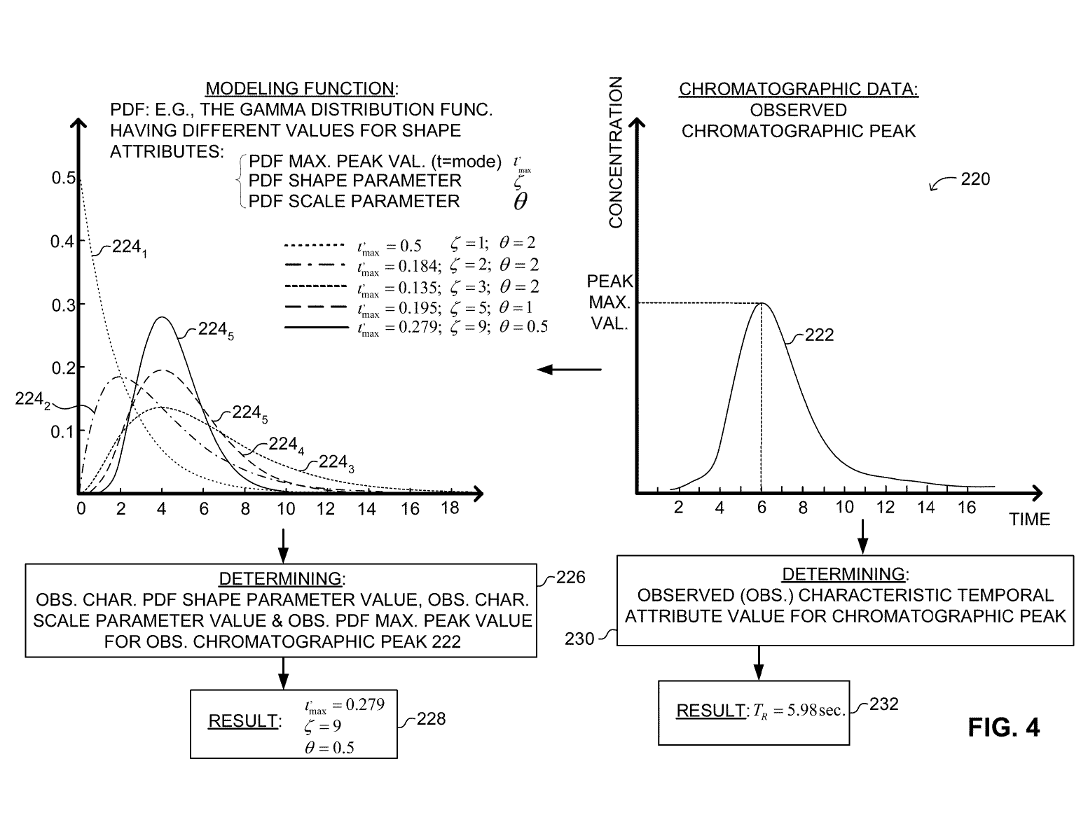

To further elucidate the present embodiment, reference is now made to FIG. 4, which is a schematic diagram illustrating fitting of a modeling function to an observed chromatographic peak for the determination of observed shape attribute values of the observed chromatographic peak. Suppose chromatographic data is acquired from a sample, as represented on the rightward part of FIG. 4 by a chromatogram 220 that includes an observed chromatographic peak 222. The leftward part of FIG. 4 illustrates multiple graphs 224₁, 224₂, 224₃, 224₄, and 224₅ of a gamma distribution function (i.e., the modeling function) for different values of the following example shape attributes: the shape parameter, ζ, of the modeled gamma distribution function, the scale parameter, θ, of the modeled gamma distribution function, and ιₘₐₓ′ (i.e., the maximum value of the gamma distribution function when t equals the mode position), as parameterized in equations (3) and (4). Other shape attribute may be used, such as the mean parameter, rate parameter, and variance of the modeling function, as well as the degree of asymmetry (values), and slope (values at certain points in time) of the probability distribution function (e.g., modeled). Additionally, other types of modeling functions may be employed, for example Maxwell-Boltzman distribution, EMGs, polynomial modified Gaussian functions, and the like. Processor 108 (FIG. 1) models observed chromatographic peak 222 (FIG. 4) with a modeling function (e.g., the gamma distribution function, equation (3)) so as to determine (represented as block 226 in FIG. 4) its respective observed PDF maximal value at mode position, the observed characteristic PDF shape parameter value and observed PDF characteristic scale parameter value, by known mathematical techniques (e.g., optimization, etc.). The result (represented as block 228 in FIG. 4) as determined by processor 102 is that the observed PDF maximal value is ιₘₐₓ′=0.279, the observed characteristic shape parameter value is ζ=9 and the observed characteristic scale parameter value is θ=0.5. Processor 108 further determines a respective observed characteristic temporal attribute for each one of the observed chromatographic peaks (represented as block 230). The characteristic temporal attribute may be the retention time (i.e., the time for which maximum value of the detector response is detected), the mean position of the chromatographic peak in the time domain, and the like. For the example given in FIG. 4, processor 108 determines the retention time for observed chromatographic peak 222, the result of which (represented as block 232) is T_{R}=5.98 seconds.

Similarly, processor 108 determines for each reference chromatographic peak in the database, respective shape attribute values, by substantially fitting a modeling function to each reference chromatographic peak. The modeling function is given in equation (2). In particular, reference shape attributes that characterize a particular reference chromatographic peak may include a reference PDF maximum value (when t=mode position), a PDF reference shape parameter value, and a reference scale parameter value. Furthermore, processor 108 determines a respective reference characteristic temporal attribute value for each one of the reference chromatographic peaks. The reference characteristic temporal attribute value may be chosen as the retention time.

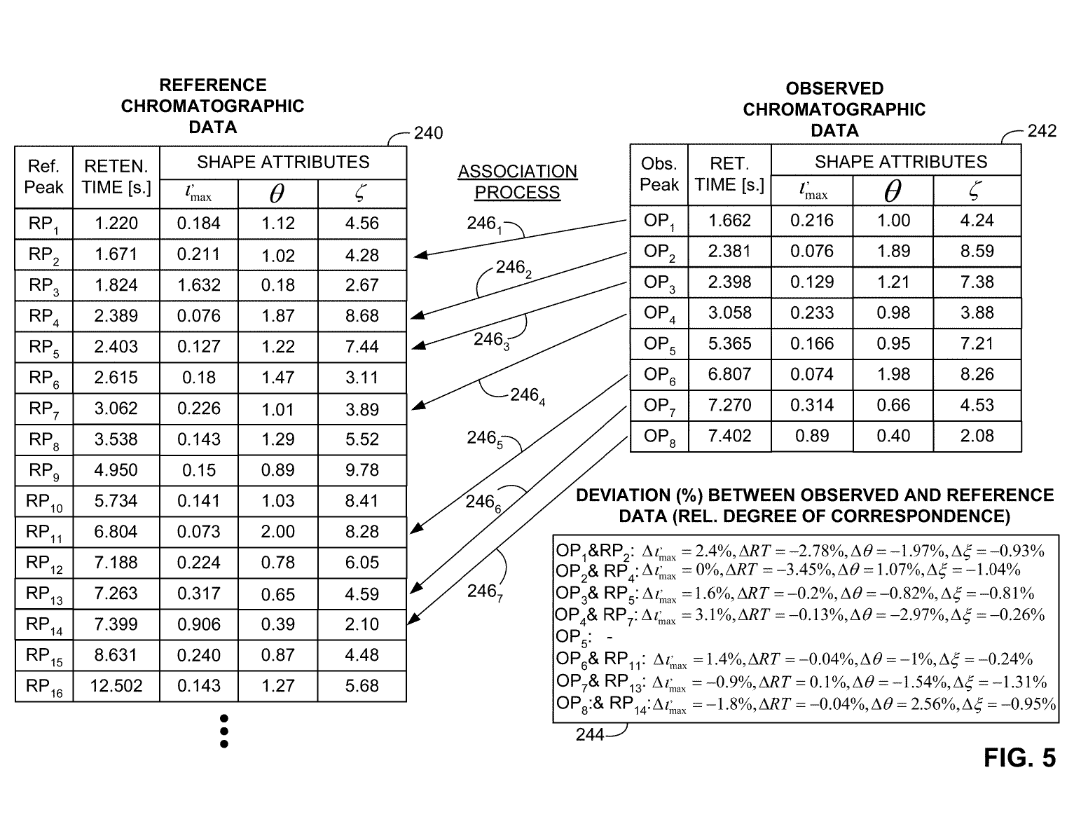

Essentially, the system and method of the present implementation of the disclosed technique may characterize each observed chromatographic peak by at least three attributes. Similarly, each reference chromatographic peak may be characterized by at least three attributes. Particularly, each observed chromatographic peak may be characterized by at least three of the following: at least one observed PDF maximum peak value (i.e., occurring at a particular time), at least one observed characteristic PDF shape parameter value, at least one observed characteristic PDF scale parameter value, and at least one observed temporal attribute value (e.g., an observed retention time value). Similarly, each reference chromatographic peak may be characterized by at least three of the following: at least reference PDF maximum peak value (i.e., occurring at a particular time), at least one reference PDF shape parameter value, at least one reference PDF scale parameter value, and at least one reference temporal attribute value (e.g., a reference retention time value). For each observed chromatographic peak, there corresponds an observed point (i.e., a data item, a data object, a one-dimensional array: vector) within the shape attributes versus time domain. The position of the observed point within the shape attributes versus time domain is defined by corresponding values of its observed shape attributes as well as its observed temporal attribute value. Similarly, for each reference chromatographic peak, there corresponds a reference point within the shape attributes versus time domain. The position of the reference point within the shape attributes versus time domain is defined by corresponding values of its reference shape attributes as its reference temporal attribute value. Processor 108 compares and associates each observed point with at least one of the reference points. In particular, for each observed chromatographic peak, processor 108 (FIG. 1) compares and associates its observed PDF maximum peak value, its observed characteristic shape parameter value, its observed characteristic scale parameter value, and its observed temporal attribute value (e.g., the observed retention time value) with respective reference chromatographic data (i.e., reference PDF maximum peak value, reference shape parameter value, reference scale parameter value, reference temporal attribute value) belonging to reference chromatographic peak. To further elucidate this association process, reference is now made to FIG. 5, which is a schematic diagram illustrating the process of associating observed chromatographic data with reference chromatographic data according to the degree of correspondence of various criteria therebetween.

FIG. 5 illustrates different databases that are represented for simplicity, as three tables 240, 242, and 244. Table 240 represents reference chromatographic data stored in database 110 that includes a plurality of reference chromatographic peaks (i.e., denoted by “RP₁”, “RP₂”, “RP₃”, etc.) each of which is tabulated with its characterizing values for reference retention time value (in seconds), reference PDF maximum peak value ιₘₐₓ′, reference characteristic scale parameter value θ, and reference characteristic shape parameter value ζ.

Table 242 represents observed chromatographic data that includes a plurality of observed chromatographic peaks (i.e., denoted by “OP₁”, “OP₂”, “OP₃”, etc.) each of which is tabulated with its characterizing values for observed retention time value (in seconds), observed PDF maximum peak value ιₘₐₓ′, observed characteristic scale parameter value θ, and observed characteristic shape parameter value ζ. The association processes as implemented by processor 108, involves comparing and associating each observed chromatographic peak OP₁, OP₂, etc. with a respective reference chromatographic peak RP₁, RP₂, etc., stored in database 110, according to their respective characterizing values. Table 244 represents a compilation of data pairs that quantify the degree of deviation (in percent) between observed data and respective reference data associated therewith. The degree of correspondence between observed data and reference data is directly related to the deviation therebetween and may be calculated by subtracting the deviation (%) from 100%. The values of the shape attributes and retention times presented in tables 240 and 242 do not represent raw experimental data and should be taken simply as examples used primarily for the purpose of explicating the disclosed technique.

The association process first involves comparing observed temporal attribute values for each observed chromatographic peak with respective reference temporal attribute values of respective reference chromatographic peaks, according to the degree of correspondence therebetween. The temporal attribute is typically the retention time. For example, the observed retention time value of observed chromatographic peak OP₁ (i.e., 1.662 seconds) is compared with the reference retention time values of the reference chromatographic peaks. The closest match is that which belongs to reference chromatographic peak RP₂ (i.e., value of 1.671 seconds). The degree of correspondence therebetween (in percent of deviation therebetween) is −2.78%, indicated in the top first row in table 244 for OP₁&RP₂ as “ΔRT=−2.78%”. (Hence, the degree of correspondence, in this case, is 100%−2.78%=97.22%). A maximal threshold value for the deviation between observed retention times (in general, for an observed temporal attribute) and reference retention times (in general, for a reference temporal attribute) is typically defined, above which it is supposed that there is no association between their respective chromatographic peaks. Conversely, a minimal threshold value for the degree of correspondence between observed retention times (in general, for an observed temporal attribute) and reference retention times (in general for an observed temporal attribute) may also be defined, below which it is supposed that there is association between their respective chromatographic peaks. Since the observed retention time value of OP₁ deviates by −2.78%, with respect to the reference retention time value RP₂ and is within the bounds of the maximal threshold in this example of ±3.5%, the association process then associates observed chromatographic peak OP₁ with reference chromatographic peak RP₂, as indicated in FIG. 5 by arrow 246₁. For brevity, the association between observed chromatographic peak OP₁ and reference chromatographic peak RP₂ is denoted in table 244 as “OP₁&RP₂”. The deviation (%) between observed PDF maximum peak value ιₘₐₓ′, of observed chromatographic peak OP₁ with respect to the reference PDF maximum peak value of reference chromatographic peak RP₂ is tabulated in table 244 as ιₘₐₓ′. Similarly, the deviation (%) between observed characteristic shape parameter value of observed chromatographic peak OP₁ with respect to reference characteristic shape parameter value of reference chromatographic peak RP₂ is tabulated in table 244 as Δθ for OP₁&RP₂. Likewise, the deviation (%) between observed characteristic scale parameter value of observed chromatographic peak OP₁ with respect to reference characteristic shape parameter value of reference chromatographic peak RP₂ is tabulated in table 244 as Δζ for OP₁&RP₂.

Analogously for the other associations, arrow 246₂ indicates an association between observed chromatographic peak OP₂ and reference chromatographic peak RP₄ (i.e., for the OP₂&RP₄ association), arrow 246₃ indicates an association between observed chromatographic peak OP₃ and reference chromatographic peak RP₅ (i.e., for the OP₃&RP₅), etc. Note that in this example, there may be observed chromatographic peaks that are not associated with any of the reference chromatographic peaks in the database, as is, for example, in the case of observed chromatographic peak OP₅, whose retention time value (i.e., 5.365 seconds) deviates more than the preset maximal threshold value from any of the reference retention time values present in the database. The association process is performed in the time domain as well as in the shape attributes domain.

After an observed chromatographic peak (e.g., OP₁) is associated with a respective reference chromatographic peak (e.g., RP₂), according to the degree of their correspondence in the time domain (i.e., between the respective observed retention and the respective reference retention time), processor 108 estimates a measure of match between the observed chromatographic peak and the reference chromatographic peak in the shape attributes domain. Specifically, processor 108 estimates a measure of match according to a degree of fitness between the observed PDF maximum peak value of an observed chromatographic peak (e.g., OP₁) with respect to the reference PDF maximum peak value of its associated reference chromatographic peak (i.e., RP₂). Likewise, processor 108 estimates a measure of match according to a degree of fitness between the observed characteristic shape parameter value (i.e., of the observed chromatographic peak) and the respective reference characteristic shape parameter value (i.e., of the reference chromatographic peak). Similarly, processor 108 estimates a measure of match according to a degree of fitness for other parameters, such as the scale parameter. When the degree of fitness between observed chromatographic data and reference chromatographic data (i.e., with regard to the PDF maximum peak value, the characteristic shape parameter, the characteristic scale parameters, or other parameters) is within a preset range it is said that the observed chromatographic data adequately fits to the reference chromatographic data (i.e., in accordance with the preset range). Thus, observed chromatographic peaks may be identified and substantially matched to reference chromatographic peaks not only according to the degree of correspondence in their characteristic temporal attribute values (e.g., retention time values, mode position values) but also according to the degree of correspondence of their shape attribute values (e.g., ιₘₐₓ′, θ, ζ, and the like).

Reference chromatographic peaks that are stored in database 110 are generally associated with at least one biomarker that is indicative of either one of: a healthy medical condition, an adverse medical condition, and an indeterminate medical condition (i.e., not yet known). In the context of the disclosed technique, a biomarker refers to a characteristic, which includes associations with at least one chemical compound (e.g., a VOC, typically several), and whose function is to indicate a particular state or medical condition of a biological entity (e.g., an adverse medical condition, a healthy medical condition, etc.). When observed chromatographic peaks yielded from a sample collected from an individual are associated and matched to reference chromatographic peaks, according to the degree of correspondence therebetween, it may be inferred with certain likelihood whether or not that individual has a medical condition according to the presence or absence of those biomarkers. Naturally, the system and method of the disclosed technique assesses the likelihood to the presence or absence of those medical conditions whose respective biomarker data indicative thereto (i.e., chromatographic data) are present in database 110. There are VOCs that are only associated with a biomarker that is indicative of a particular medical condition, and there are those VOCs which may be associated with two different biomarkers, each indicative of contrasting medical conditions (i.e., of adverse and healthy classifications). In case a particular combination of VOCs is associated with two contrasting biomarkers of differing classifications, each of which is indicative of either a healthy medical condition or an adverse medical condition, a decision rule may be defined. Such a decision rule defines a threshold number of occurrences of that combination of VOCs in the samples collected from individuals, above which a diagnosis is adverse. Hence, if the number of occurrences of a particular combination of VOCs associated with two contrasting biomarkers passes a threshold number, the diagnosis is weighted toward the adverse medical condition. This threshold number may vary according to the size of the sample space that is stored and catalogued in the database pertaining to VOCs, their associated biomarkers as well as to the number of occurrences for each case for a plurality of individuals.

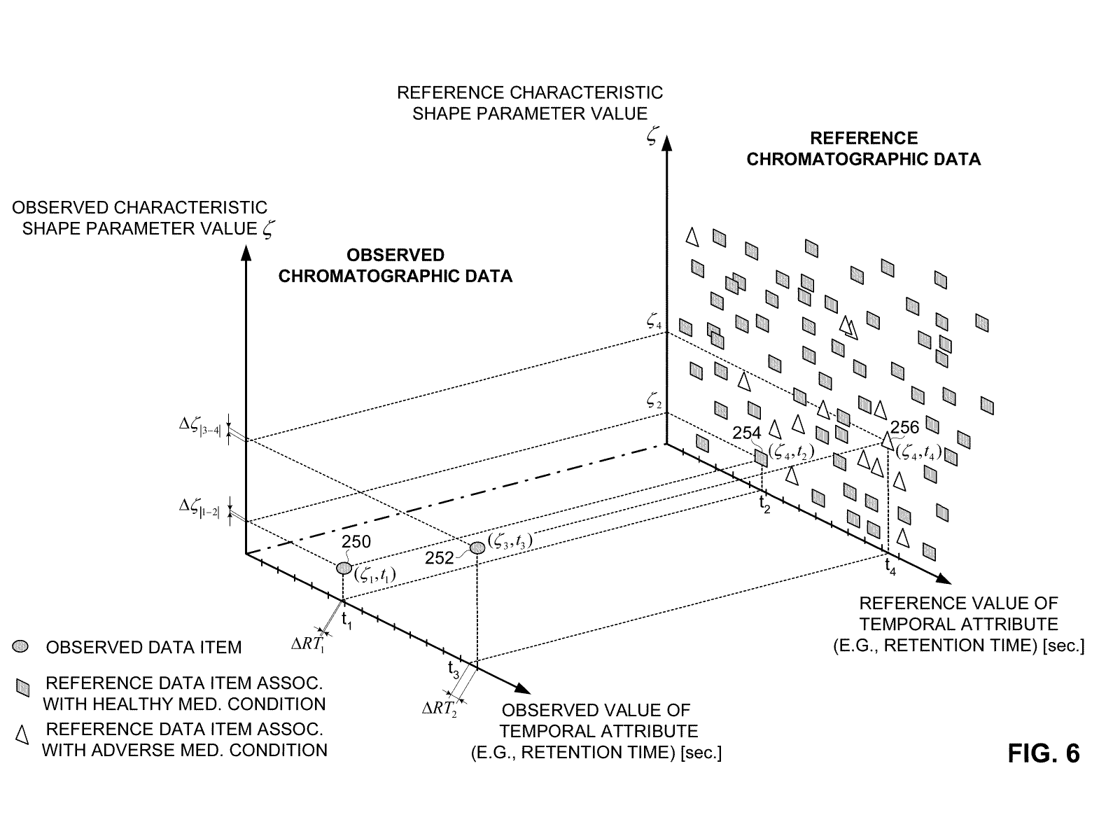

Graphically, the representation and analysis of chromatographic data is performed in a chromatographic shape attributes versus temporal attribute (time) domain. Generally, an N-dimensional coordinate system is defined whose at most N−1 coordinates are at least one of the shape attributes and at least one coordinate is at least one temporal attribute (e.g., the retention time). Typically, in the simple two-dimensional (2-D) case, a coordinate system is defined as having a first coordinate that is at least one of the shape attributes and a second coordinate that is the retention time. To further explicate the details of this representation, reference is now made to FIG. 6, which is a schematic illustration showing a representation of observed and reference chromatographic data in the shape parameter versus time domain.

FIG. 6 illustrates two Cartesian coordinate systems (i.e., one positioned on the left and the other on the right) in the chromatographic shape attributes versus time domain. Alternatively, other types of coordinate systems may be employed (e.g., polar, curvilinear, etc.). The coordinate system on the left represents the observed chromatographic data in the chromatographic shape attributes versus time domain, whereas the coordinate system on the right represents the reference chromatographic data also in the chromatographic shape attributes versus time domain. These coordinate systems are practically identical, as in essence one coordinate system would suffice, although graphically two are employed herein for the purpose of better elucidating the disclosed technique. In general, for both coordinate systems, the vertical axis is one of the shape attributes (e.g., the characteristic shape parameter) thereby defining a “first coordinate” of a point in the respective coordinate system), while the horizontal axis is the time thereby defining a “second coordinate” of a point in the respective coordinate system. The coordinate system of the reference chromatographic data includes a plurality of data items represented by different shapes (i.e., these data items are essentially points, which are exaggerated in size for clarification purposes). Rhombus shaped data items represent reference chromatographic data associated with at least one biomarker that is indicative of a healthy medical condition. Triangle shaped data items represent reference chromatographic data associated with at least one biomarker that is indicative of an adverse medical condition. The elliptical shaped data items shown in the coordinate system of the observed chromatographic data represent observed chromatographic data. All data items are thus represented in the shape attributes versus time domain, and in this case given in FIG. 6, the shape parameter ζ versus the retention time. Alternatively, other forms of representation may be employed, for example data items may positioned in the scale parameter versus mode position domain, or combinations thereof. For example, a three dimensional coordinate system may be employed, where data items are represented in a domain defined by two shape attributes (e.g., shape parameter ζ, and the scale parameter θ) versus time. In general, the mode position is a measure of the chromatographic peak width in time retention dimensions, such as peak width at half height, peak width at inflection points, peak width at base, and the like.

In the illustrative example given in FIG. 6, two observed data items 250 and 252 are shown (for simplicity), each representing a respective observed chromatographic peak within the characteristic shape parameter versus retention time domain. Observed data items 250 and 252 possess the coordinates (ζ₁,t₁), and (ζ₃,t₃) respectively. For an observed data item (e.g., 250, 252), processor 108 associates at least one reference data item according to a degree of correspondence between the value of its coordinates compared to those of reference data items. In other words, given a position (i.e., the coordinates) of an observed data item, processor 108 finds (i.e., identifies and associates) a reference data item whose position (i.e., coordinates) most closely matches (e.g., position-wise, distance-wise) to that of the observed data item. A distance function is defined (not shown) where typically, the distance in the horizontal direction (i.e., that of the temporal attribute—retention time) may have greater weight than the distance in the vertical direction (i.e., that of the characteristic shape parameter). In the example given in FIG. 6, processor 108 determines that observed data item 250 is to be associated with reference data item 254, possessing the coordinates (ζ₂,t₂), since the degree of correspondence therebetween is maximal (i.e., the degree of deviation is minimal) relative to other existing reference data items (i.e., within the bounds of predetermined threshold values). The deviation therebetween with respect to their retention time values is denoted by ΔRT₁ and with respect to their characteristic shape parameter values is denoted by Δζ_{|1-2|}. Similarly, processor 108 determines that observed data item 252 is to be associated with reference data item 256, possessing the coordinates (ζ₄,t₄) and the degree of deviation therebetween is ΔRT₂ with respect to their retention time values and Δζ_{|3-4|} with respect to their characteristic shape parameter values. The degree of correspondence is directly related to the degree of deviation. Generally, a degree of deviation by x % would be equivalent to a degree of correspondence of (100−x) % and vice versa.

Accordingly, gas chromatographic data that is acquired from a sample taken from an individual may be analyzed so as to probabilistically determine the presence or absence of biomarkers that may be indicative of either one of a healthy medical condition, an adverse medical condition, and an indeterminate medical condition. In the example given in FIG. 6, two observed data items 250 and 252 are shown, each corresponding to a respective observed chromatographic peak. Observed data item 250 is associated with reference data item 254, which in turn is associated with a biomarker that is indicative of a healthy medical condition (i.e., not correlated with any known diseases). Conversely, observed data item 252 is associated with reference data item 256, which in turn is associated with a biomarker that is indicative of an adverse medical condition.

Alternatively, a graphical representation in higher dimensions (e.g., a three-dimensional coordinate system) may be employed to map the observed and reference chromatographic data, for example in the observed PDF maximal value versus characteristic scale parameter versus retention time domain (not shown).

Database 110 is constructed and compiled to store the plurality of reference data items whose respective reference chromatographic peaks are associated with respective biomarkers that are indicative of a particular medical condition. One such method to compile the database is to acquire chromatographic data from individuals with the foreknowledge of their respective medical conditions. For example, to compile a database of chromatographic peaks that are associated with biomarkers indicative of a particular adverse medical condition (e.g., colon cancer), samples from individuals confirmed having that particular adverse medical condition are collected and analyzed by system 100. Chromatographic data (i.e., peaks, retention times, characteristic shape parameters, and the like) yielded from the samples (e.g., VOCs) via system 100 that are common to all individuals (i.e., or at least part of the total number of individuals) are used to characterize a particular biomarker that may be used to probabilistically indicate the presence of that adverse medical condition. Once the database is compiled for a particular medical condition, an individual having no foreknowledge of having that medical condition may be tested, to probabilistically determine the presence or absence of that medical condition. Generally, the more reference data that is acquired in the database (i.e., from a broad diversity of individuals) the more accurate the probabilistic assessment to the presence or absence of a particular medical condition for a tested individual would become. Naturally, some tests are indeterminate as to the particular medical condition of a tested individual.

The representation of reference chromatographic data (i.e., reference data items) in the shape attributes versus retention time domain has revealed the occurrence of clusters (i.e., aggregations) of reference data items that exhibit similar attributes. In particular, clusters of reference data items all of whose respective reference chromatographic peaks are associated with a biomarker that is indicative of a particular medical condition have been found. A cluster is hereby defined as a grouping of a number of similar objects (e.g., reference data items, observed data items). The cluster may be defined according to occurrence in time and/or position (i.e., in a coordinate system) and/or the relative distances between each of the objects. A set of criteria are established to characterize clusters of chromatographic (reference and observed) data items. This set of criteria defines which of the data items within the defined shape attributes versus time domain constitute a cluster of data items. In other words, given a plurality of data items within the shape attributes versus time domain, the set of criteria define which data items form (or are to be grouped or belong to) a particular cluster and which do not. This set of criteria may include a metric function, which defines the maximal distance between different data items such that they would be considered a cluster of data items. The set of criteria further includes a definition of a data cluster boundary, which defines the maximal distance from at least one of the data items in a data item cluster beyond which a data item in question would not be considered part of the data cluster. In two-dimensional space (e.g., characteristic shape parameter versus time domain), the data cluster boundary may be described by the area enclosed by its respective data cluster boundary. In three-dimensional space, the data cluster boundary may be described by the volume enclosed by its respective data cluster boundary, and so forth.

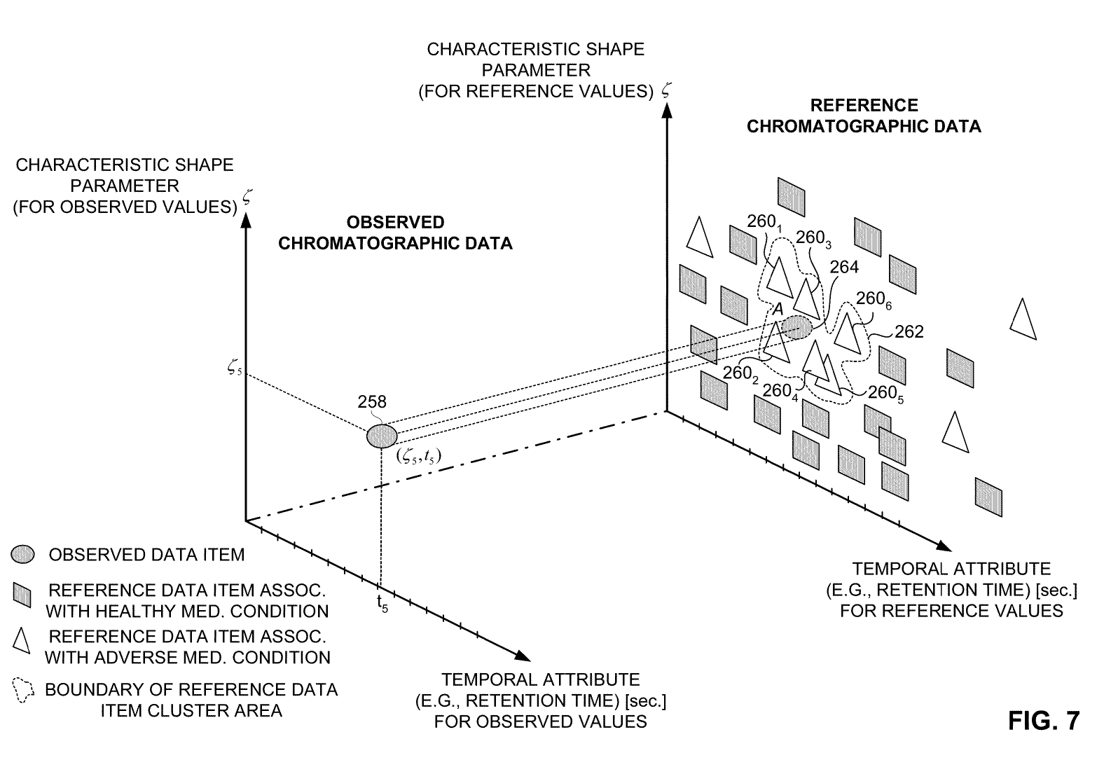

The system and method of the disclosed technique employ statistical analysis techniques such as cluster analysis techniques on chromatographic data to assess whether observed chromatographic data are linked with reference chromatographic data stored in the database. To further demonstrate the use of cluster analysis techniques employed, reference is now made to FIG. 7, which is a schematic illustration showing cluster analysis techniques employed to assess whether observed chromatographic data are linked with reference chromatographic data within the shape attributes versus time domain. FIG. 7 is generally similar to FIG. 6, apart from the main difference that the both observed and reference data items have been enlarged so as to accentuate the cluster analysis technique that is employed. Processor 108 is operative to employ methods of statistical analysis such as cluster analysis techniques (e.g., centroid-based clustering, distribution-based clustering, density-based clustering, and the like) so as to identify at least one reference data item cluster that includes a plurality of reference data items all of whose respective reference chromatographic peaks are associated with a biomarker that is indicative of either one of a healthy medical condition, an adverse medical condition, and an indeterminate medical condition. The reference chromatographic data, as shown in FIG. 7, includes a plurality of reference data items, and among others in particular, reference data items 260₁, 260₂, 260₃, 260₄, 260₅, and 260₆ shown in the shape attribute versus retention time domain. In particular, the shape attribute chosen for demonstrating principles of the disclosed technique in FIG. 7 is the characteristic shape parameter ζ. Other shape attributes may equally be used, such as the PDF maximal value at mode position ιₘₐₓ′, the scale parameter 19, etc. Processor 108 identifies reference data items 260₁, 260₂, 260₃, 260₄, 260₅, and 260₆, according to cluster analysis techniques, as a reference data item cluster 262 whose constituents have the common attribute of being associated with a particular biomarker that is indicative of a particular adverse medical condition (i.e., all graphically represented by triangle symbol in FIG. 7). Reference data item cluster 262 defines a boundary (i.e., represented by dashed line) that surrounds a closed perimeter enclosing all of reference data items 260₁, 260₂, 260₃, 260₄, 260₅, and 260₆ into an area defined and denoted by “A” within the characteristic shape parameter versus retention time domain. Thus, reference data item cluster 262 may be defined by the area, A, that collectively encloses reference data items 260₁, 260₂, 260₃, 260₄, 260₅, and 260₆. During a “learning mode” of system 100, as more reference data items are added into the database, this area for each identified reference data cluster may dynamically change (i.e., in terms of shape, dimensions, etc.). A particular cluster may represent a particular VOC, which in turn its detected presence in a collected sample may represent a biomarker that may or may not be indicative of a particular medical condition of an individual from whom this sample was acquired.

Once identification and characterization (i.e., geometrically, in terms of position, etc.) of reference data item clusters in the database is performed, newly acquired observed chromatographic data items may be assessed to determine whether they may be associated with the reference data items clusters according to their position in the shape attributes versus temporal attribute domain. For example, FIG. 7 shows observed data item 258 having the coordinates (ζ₅,t₅) in the characteristic shape parameter versus retention time domain. Upon analysis of observed data item 258, processor 108 determines that its position is contained within area A, defined by reference data item cluster 262 (i.e., graphically represented as projection 264). In this example, observed data item 258 is not specifically associated with a particular one of reference data items 260₁, 260₂, 260₃, 260₄, 260₅, and 260₆ but rather reference data item cluster 262 bounded by area A. According to the degree of correspondence (or analogously, the degree of deviation) between the position of observed data item 258 in relation to reference data item cluster 262, processor 108 probabilistically determines whether observed data item 258 is associated with the same biomarker that is associated with reference data item cluster 262. Since the association of a particular data item to either one of a healthy medical condition, an adverse medical condition, and an indeterminate medical condition is based on statistical factors (e.g., the size of the sample space, i.e., number of tested and verified individuals), the determination is probabilistic. In the marginal case where an observed data item coincides with the boundary of a data cluster processor 108 is operative to evaluate if the particular biomarker is to be associated with reference data item cluster in question.

Hence, statistical methods such as cluster analysis techniques, machine learning techniques, and the like are thus used to determine whether an observed data item in the shape attributes versus time attributes space (domain), corresponding to a chromatographic peak, is associated with either one of a healthy medical condition, an adverse medical condition, and an indeterminate medical condition according to the position of that observed data item in that domain, in relation to a defined boundary of at least one reference data item cluster in that domain. Furthermore, this determination may also be based on the number of occurrences in the positions of respective observed data items in relation to the defined boundary of the reference data item cluster.

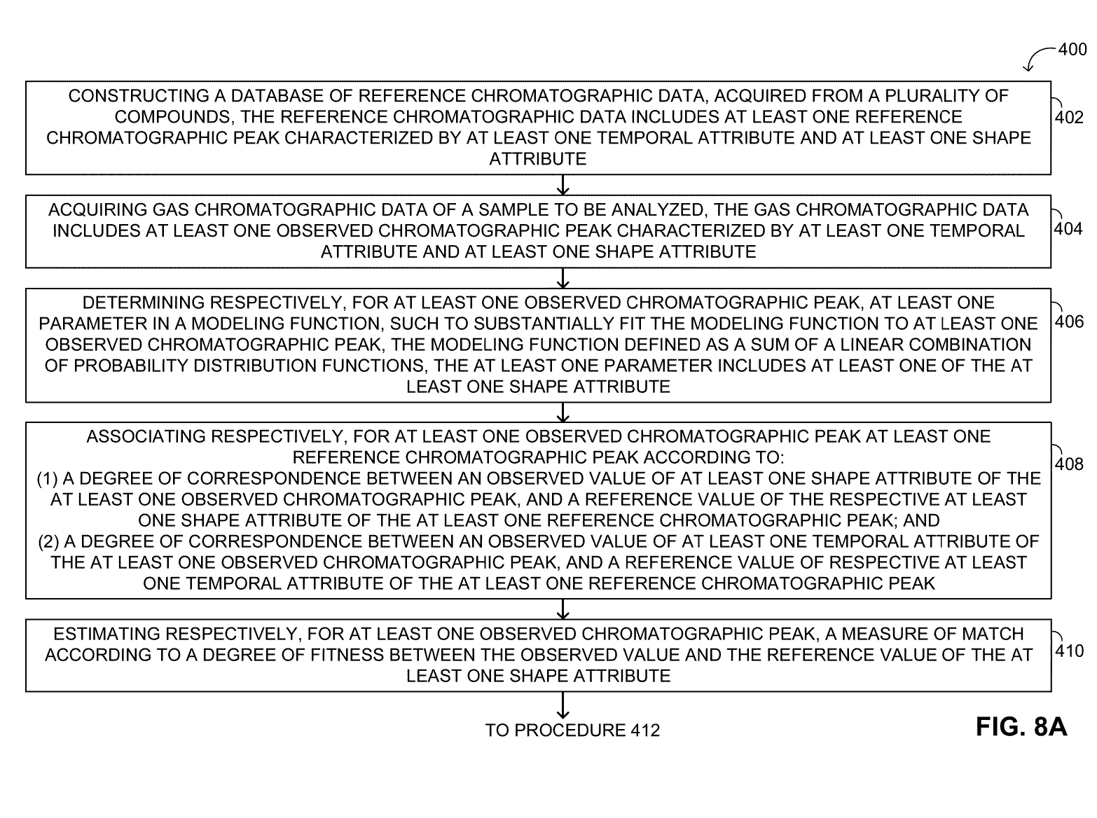

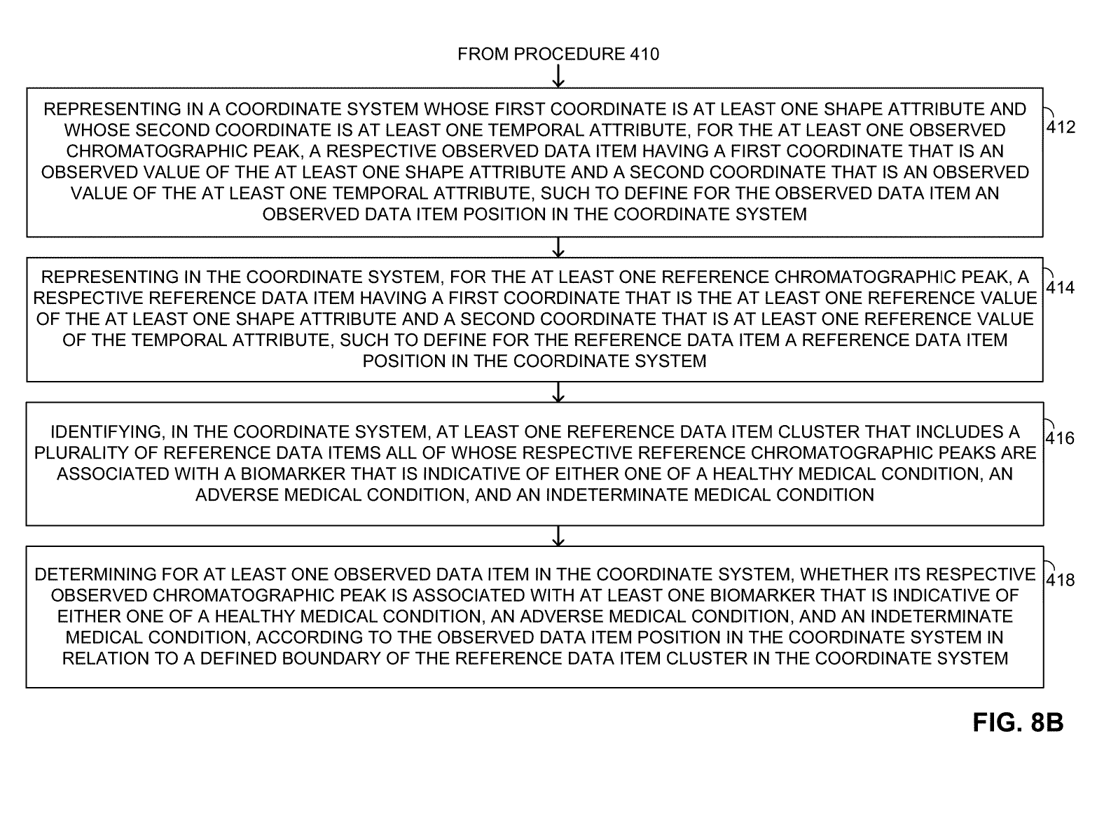

Reference is now made to FIGS. 8A and 8B. FIG. 8A is a schematic block diagram illustrating a method that employs self-reliant gas chromatography for determining a measure of match between acquired gas chromatographic data respective of a sample and reference data, generally referenced 400, constructed and operative according to a further embodiment of the disclosed technique. FIG. 8B is a schematic block diagram illustrating a continuation of the method from FIG. 8B. In procedure 402 (FIG. 8A), a database of reference chromatographic data is constructed from a plurality of compounds; the reference chromatographic data includes at least one reference chromatographic peak characterized by at least one temporal attribute and at least one shape attribute. With reference to FIGS. 1 and 5, system 100 (FIG. 1) acquires, via detector 106 chromatographic data from a plurality of compounds so as to construct a database of respective reference chromatographic data to be stored in memory 110. The reference chromatographic data includes at least one reference chromatographic peak RP₁, RP₂, . . . , RP₁₆ . . . (i.e., table 240 in FIG. 5) characterized by at least one temporal attribute (e.g., retention time in table 240) and at least one shape attribute (e.g., PDF maximal value ιₘₐₓ′, shape parameter 8 and scale parameter ζ in table 240). The compiling or construction of the database of reference gas chromatographic data is acquired from a plurality of compounds (e.g., VOCs), whose sources (e.g., individuals, patients) are known to be associated with either one of a healthy medical condition, and an adverse medical condition.

In procedure 404 gas chromatographic data of a sample to be analyzed is acquired; the gas chromatographic data includes at least one observed chromatographic peak characterized by at least one temporal attribute and at least one shape attribute. With reference to FIGS. 1, 4 and 5, gas chromatographic data of a sample is acquired by system 100 (FIG. 1). The gas chromatographic data includes at least one observed chromatographic peak 222 (FIG. 4) and OP₁, OP₂, . . . , OP₈ (table 242 in FIG. 5) characterized by at least one temporal attribute (e.g., retention time in table 242 of FIG. 5) and at least one shape attribute (e.g., PDF maximal value ιₘₐₓ′, shape parameter θ and scale parameter in table 242 of FIG. 5).

In procedure 406, at least one parameter in a modeling function is respectively determined for at least one observed chromatographic peak, such to substantially fit the modeling function to at least one observed chromatographic peak. The modeling function is defined as a sum of a linear combination of probability distribution functions. The at least one parameter includes at least one of the at least one characteristic shape parameter. With reference to equations (2), (3) and FIG. 4, parameters βⱼ, ηₖ, δₗ and ιₘ in the modeling function defined in equation (2) and parameters ζ, and θ in equation (3) are respectively determined for at least one observed chromatographic peak 222 (FIG. 4), such to substantially fit the modeling function to observed chromatographic peak 222. The modeling function is defined as a sum of a linear combination of probability distribution functions Dᵢⱼ(t), Hₖ(t), O₁(t), and Iₘ(t). The at least one parameter includes at least one of the at least one shape attribute, e.g., ζ, θ, etc.

In procedure 408, for at least one observed chromatographic peak, at least one reference chromatographic peak is associated according to: a degree of correspondence between an observed value of at least one shape attribute of the at least one observed chromatographic peak, and a reference value of the respective at least one shape attribute of the at least one reference chromatographic peak; and a degree of correspondence between an observed value of at least one temporal attribute of the at least one observed chromatographic peak, and a reference value of respective at least one reference temporal attribute of the at least one reference chromatographic peak. With reference to FIG. 5, observed chromatographic peak OP₁ (table 242) is associated (arrow 246₁) with reference chromatographic peak RP₂ (table 240) according to a degree of correspondence (Δθ=−1.97%) between an observed value of a characteristic shape parameter θ (θ=1.00) and a reference value respective of a characteristic shape parameter θ (θ=1.02). Also, a degree of correspondence (ΔRT=−2.78%) between an observed value of a temporal attribute (e.g., retention time=1.662 sec.) and a reference value respective of reference temporal attribute (e.g., retention time=1.671 sec.) of reference chromatographic peak RP₂.

In procedure 410, for at least one observed chromatographic peak, a measure of match is estimated respectively, according to a degree of fitness between the observed value and a reference value of the at least one shape of the at least one shape attribute. With reference to FIG. 5, the measure of match is estimated between observed chromatographic peak OP₁ (table 242) and reference chromatographic peak RP₂ (table 240) according to a degree of correspondence (Δθ=−1.97%) between an observed value of a characteristic shape parameter θ (θ=1.00) and a reference value respective of a characteristic shape parameter θ (θ=1.02).

In procedure 412 (FIG. 8B), for at least one observed chromatographic peak, a respective observed data item is represented in a coordinate system whose first coordinate is at least one shape attribute and whose second coordinate is at least one temporal attribute; the observed data item having a first coordinate that is an observed value of the at least one shape attribute and a second coordinate that is an observed value of the at least one temporal attribute, such to define for the observed data item an observed data item position in the coordinate system. With reference to FIG. 6, observed data item 250, representing an observed chromatographic peak, is represented in a coordinate system whose first coordinate is θ and whose second coordinate is the retention time. Observed data item 250 has a first coordinate ζ₁ that is an observed value of the characteristic shape parameter ζ and a second coordinate t₁ that is an observed value of the retention time, such to define for observed data item 250 the coordinates (ζ₁, t₁) in the coordinate system.

In procedure 414, for at least one reference chromatographic peak, a respective reference data item is represented in the coordinate system; the reference data item having a first coordinate that is the at least one reference value of the at least one shape attribute and a second coordinate that is at least one reference value of the temporal attribute, such to define for the reference data item a reference data item position in the coordinate system. With reference to FIG. 6, reference data item 254 includes a first coordinate ζ₂ and a second coordinate t₂, such to define for it the position (i.e., coordinates) (ζ₂, t₂) in the coordinate system.

In procedure 416, at least one reference data item cluster is identified in the coordinate system; the at least one reference data item cluster includes a plurality of reference data items all of whose respective reference chromatographic peaks are associated with a biomarker that is indicative of either one of a healthy medical condition, an adverse medical condition, and an indeterminate medical condition. With reference to FIGS. 1 and 7, reference data item cluster 262 (FIG. 7) is identified by processor 108 (FIG. 1) by cluster analysis techniques. Reference data item cluster includes a plurality of reference data items 260₁, 260₂, 260₃, 260₄, 260₅, and 260₆ all of whose respective reference chromatographic peaks are associated with a biomarker that is indicative of an adverse medical condition (i.e., all symbolized by triangle in FIG. 7).

In procedure 418, for at least one observed data item in the coordinate system, whether its respective observed chromatographic peak is associated with at least one biomarker that is indicative of either one of a healthy medical condition, an adverse medical condition, and an indeterminate medical condition is determined, according to the observed data item position in the coordinate system in relation to a defined boundary of the reference data item cluster in the coordinate system. With reference to FIGS. 1 and 7, processor 108 (FIG. 1) determines whether observed data item 258 (FIG. 7) is associated with a biomarker that is indicative of either one of a healthy medical condition, an adverse medical condition, and an indeterminate medical condition, according to its position (θ₅, t₅) in the coordinate system in relation (e.g., graphically demonstrated by projection 264) to a defined area, A, of reference data item cluster 262.

The preceding description in conjunction with FIGS. 4, 6, 7, 8A and 8B hereinabove are presented for the purposes of elucidating the disclosed technique. For simplicity, a graphical representation in the Euclidean Cartesian coordinate system was chosen; however, the principles of the disclosed technique are invariant and not limited to the type of representation used. In particular, the representation of data in a data space (e.g., of chromatographic data, “chromatographic data space”) may ensue in various different representations, coordinate systems, computer data structures, domains and dimensions. According to an alternative representation, the system and method of the disclosed technique may define an N-dimensional data space, where at least one dimension corresponds with at least one temporal attribute (of the chromatographic data, modeled chromatographic data), and each of the remaining dimensions (generally, at least one) in the N-dimensional data space respectively correspond with different shape attributes. ‘N’ may be defined as a non-negative integer. For example, there may be defined a 5-D (five dimensional, N=5) data space, where the first dimension is time retention, and the other 4 dimensions are the characteristic shape parameter ζ (of the modeled probability distribution function), the scale parameter θ, the mean parameter, and the maximum value of the modeled probability distribution function the ιₘₐₓ′. The observed and reference chromatographic peaks may be represented in the general N-dimensional data space respectively as observed data items and reference data items. Chromatographic data represented in such an N-dimensional data space may be subject to statistical analysis by the system and method of the disclosed technique so as to assess whether the observed chromatographic peak is associated with at least one biomarker that is indicative of either one of a healthy medical condition, an adverse medical condition, and an indeterminate medical condition, from a subject from whom said sample is acquired. In general, statistical analysis techniques that are used by the system and method may include cluster analysis, discriminant analysis, machine learning techniques, and the like. The statistical analysis is typically facilitated by at least one decision rule that is based on the incidence of correspondences, between the observed data items and the reference data items, according to at least one statistical criterion. For example, a decision rule may be based on a threshold value for the incidence of observed data items positioned at a particular defined interval (1-D case), area (2-D case), or volume (general N-dimensional case) within the N-dimensional data space. A statistical criterion may be, for example, a metric (e.g., distance) between the defined volume and the closest reference data item. Alternatively, the statistical criterion may generally be any statistical test and/or statistical parameter that may be used to characterize, assess, or statistically determine, possible values, relationships or associations between data sets (e.g., observed data and reference data). Generally, in this example, based on the decision rule and statistical criterion, the system and method employing a particular statistical analysis technique would determine, given a particular incidence value that is above a certain threshold value of observed data items, and positioned in a particular volume and being distanced away from the closest reference data item by a known value, the likelihood of those observed data items being classified in a certain way.

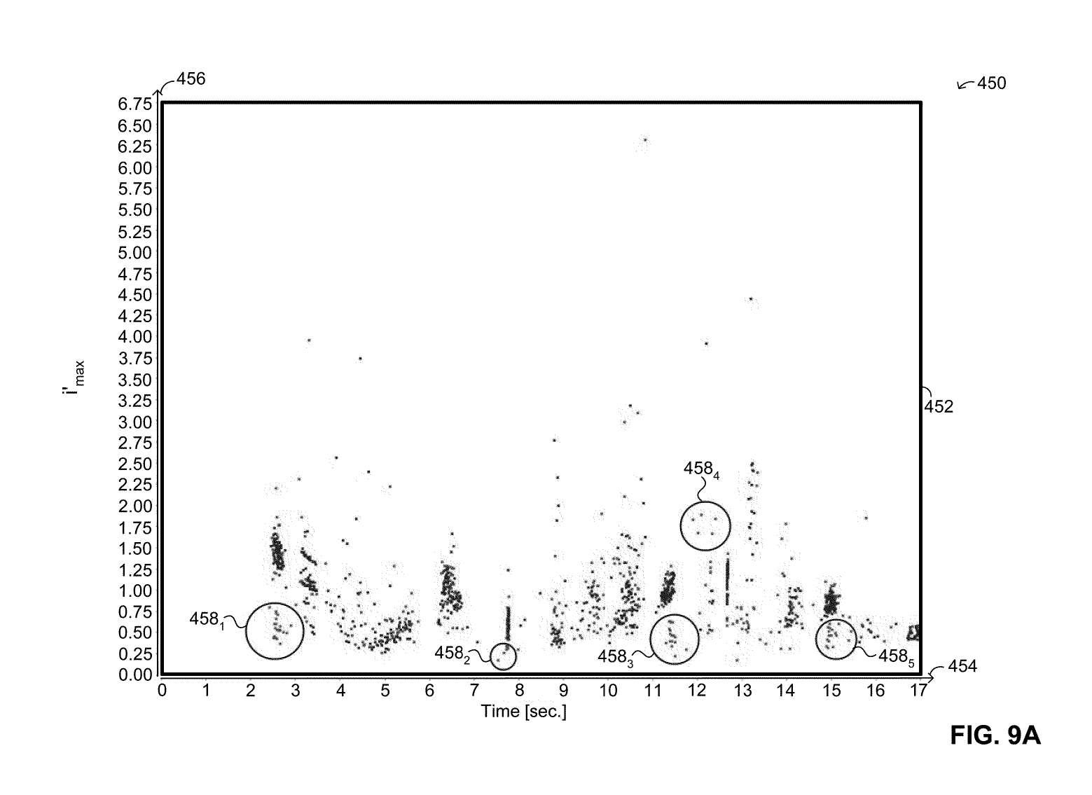

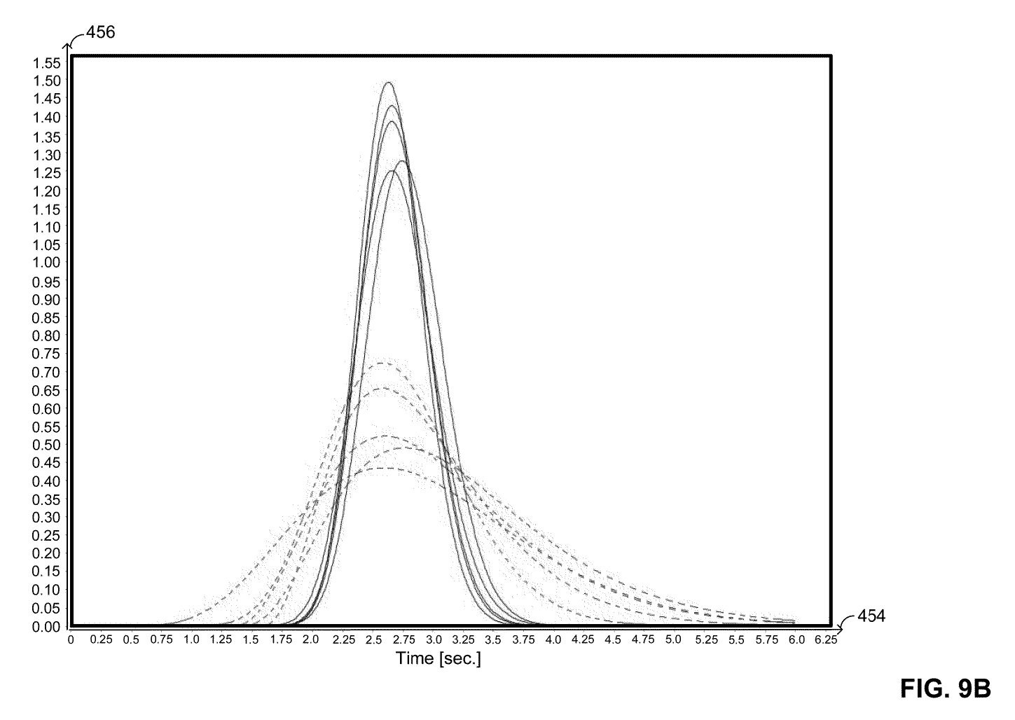

The applicability of the system and method of the disclosed technique may be demonstrated by the following example experimental results obtained from the construction of a database of reference chromatographic data. Reference is now made to FIGS. 9A and 9B. FIG. 9A is a 2-dimensional scatter plot of experimental results yielded in a construction phase of a database of reference chromatographic data, generally referenced 450, plotted in the shape attribute versus time domain. FIG. 9B illustrates 2-dimensional graphs representing modeled gamma distribution functions of the reference chromatographic data, taken from a portion of FIG. 9A, graphed in the gamma distribution function value versus time domain. The example shown in FIG. 9A shows a plurality of experimentally obtained reference data points scattered in a 2-D rectangular Euclidean coordinate system 452, where the vertical axis 454 represents a shape attribute of the modeled gamma distribution function (ιₘₐₓ′.) and the horizontal axis 456 represents time. This representation of data points, irrespective of the dimensionality and the type of coordinate system employed may be hereby generally referred interchangeably, as the “shape attribute versus time domain”, “shape attribute versus time space”, “shape attributes versus time attribute space”, or “shape attributes versus time attributes domain”.

Blue colored points (color drawings) or square shaped points (black-and-white drawings) represent (chromatographic) data items (or “data objects”) corresponding to chromatographic peaks (i.e., of chemical compounds (e.g., VOCs)) that are not known to be associated with the presence of breast cancer (i.e., adverse medical condition) in individuals. In other words, one part of the database is constructed to include reference data items corresponding to chromatographic data obtained from a plurality of healthy individuals confirmed or screened beforehand not to have a particular adverse medical condition, and in this example, breast cancer. Another part of the database is constructed to include reference data items corresponding to plurality of chromatographic peaks (chromatographic data) that are associated with at least one biomarker that is indicative to the presence of breast cancer (adverse medical condition). Red colored points (color drawings) or ‘X’-shaped points (black-and-white drawings) represent chromatographic data items (or “data objects”) corresponding to chromatographic peaks (i.e., of chemical compounds (e.g., VOCs)) that are known to be associated with the presence of breast cancer in individuals.

The shape attribute used in FIG. 9A is the ιₘₐₓ′ (i.e., the maximum value of the gamma distribution function when t equals the mode position, also denoted herein as the “distribution value”). Hence, for every reference data item corresponding to a reference chromatographic peak, FIG. 9A shows its corresponding modeled gamma distribution function value and respective time value (in seconds). Circles 458₁, 458₂, 458₃, 458₄, and 458₅ represent defined cluster boundaries of reference data items whose respective chromatographic peaks (of VOCs) are associated with at least one biomarker that is indicative of the presence of breast cancer in a patient from whom a sample was collected and analyzed. Cluster boundaries of other shapes (not shown) are also viable (e.g., polygons, closed curves, etc.). Other clusters include mixtures of both reference data items and observed data items. Each sample (e.g., collected breath sample) that is collected from a subject (individual or patient) produces a characteristic scatter pattern of observed data items in the shape attribute versus time domain. The analysis of a patient's sample entails determining whether the position of the patient's corresponding observed data items fall within (contained in) the defined boundaries of reference data item clusters. If for example, several of the observed data items are positioned within all or at least part of circles 458₁, 458₂, 458₃, 458₄, and 458₅, then that would indicate a high probability to the presence of breast cancer in that particular patient from whom the sample was acquired. If, on the other hand, the observed data items are positioned exteriorly to the defined respective borders of the clusters associated with the adverse medical condition, then that would indicate that there is a low probability to the presence of breast cancer for that patient. A third option would be if the observed data items are scattered at positions where there is a mixture of both red (or X-shaped points) and blue (or square shaped points) data items, which would indicate an indeterminate medical condition (i.e., the presence or absence of breast cancer in the individual is inconclusive). In general, the more reference data items present in the database (sample size) the greater the chance of attaining higher statistically significant results for a particular test.

FIG. 9B illustrates two sets of modeled gamma distribution functions of reference chromatographic data graphed in the gamma distribution function value (vertical axis) versus time (horizontal axis) domain specifically showing in the interval of 2 to 3 seconds. The first set of modeled gamma distribution functions (shown to have a higher vertical extent and denoted by solid line and/or blue color) represents modeled reference chromatographic peaks corresponding to blue colored points (square shaped points) in FIG. 9A (corresponding to chromatographic peaks that are not known to be associated with the presence of breast cancer in individuals). The second set of modeled gamma distribution functions (shown to have a lower relative vertical extent and denoted by a dashed (broken) line and/or colored red) represents modeled reference chromatographic peaks corresponding to red colored points (‘X’-shaped points) in FIG. 9A (i.e., corresponding to chromatographic peaks that are known to be associated with the presence of breast cancer in individuals). Owing to the property that the integral over the entire random variable's extent (e.g., time) of a probability density (distribution) function (e.g., gamma) is equal to 1, a distinction between the first and second sets may be graphed and clearly visualized. FIG. 9B shows a clear separation between the first and second sets, or in other words, between modeled gamma distribution functions corresponding to chromatographic peaks of VOCs associated with either the presence or absence of breast cancer in individuals.

1. A method that employs self-reliant gas chromatography for determining a measure of match between acquired gas chromatographic data representative of a sample and reference gas chromatographic data, the acquired gas chromatographic data includes at least one observed chromatographic peak, the reference gas chromatographic data includes at least one reference chromatographic peak, the at least one observed chromatographic peak and the at least one reference chromatographic peak are characterized by at least one temporal attribute and at least one shape attribute, the method comprising the procedures of:
determining respectively, for said at least one observed chromatographic peak, at least one parameter in a modeling function, such to substantially fit said modeling function to said at least one observed chromatographic peak, said at least one parameter includes at least one of said at least one shape attribute;
associating respectively, for said at least one observed chromatographic peak said at least one reference chromatographic peak according to:
a degree of correspondence between an observed value of said at least one shape attribute of said at least one observed chromatographic peak, and a reference value of respective said at least one shape attribute of said at least one reference chromatographic peak; and
a degree of correspondence between an observed value of said at least one temporal attribute of said at least one observed chromatographic peak, and a reference value of respective said at least one reference temporal attribute of said at least one reference chromatographic peak; and
estimating respectively, for said at least one observed chromatographic peak, said measure of match according to a degree of fitness between said observed value and respective said reference value of said at least one shape attribute, according to said procedure of associating.

2. The method according to claim 1, wherein said procedure of estimating is further according to a degree of fitness between said observed value and said reference value of corresponding said at least one temporal attribute.

3. The method according to claim 1, further comprising a procedure of representing, for said at least one observed chromatographic peak, in a coordinate system whose first coordinate is said at least one shape attribute and whose second coordinate is said at least one temporal attribute, a respective observed data item having a first coordinate that is said observed value of said at least one shape attribute, and a second coordinate that is said observed value of said at least one temporal attribute, such to define a position of said observed data item in said coordinate system.

4. The method according to claim 3, further comprising a procedure of representing in said coordinate system, for said at least one reference chromatographic peak, a respective reference data item having a first coordinate that is said reference value of said at least one shape attribute and a second coordinate that is said reference value of said at least one temporal attribute, such to define a position of said reference data item is said coordinate system.

5. The method according to claim 4, further comprising a procedure of identifying, in said coordinate system, at least one reference data item cluster that includes a plurality of reference data items all of whose respective reference chromatographic peaks are associated with a biomarker that is indicative of either one of a healthy medical condition, and adverse medical condition, and an indeterminate medical condition of a subject from whom said sample is acquired.

6. The method according to claim 5, further comprising a procedure of determining for said at least one observed data item in said coordinate system, whether its respective said observed chromatographic peak is associated with at least one said biomarker that is indicative of either one of a healthy medical condition, an adverse medical condition, and an indeterminate medical condition, according to said position of said at least one observed data item in said coordinate system in relation to a defined boundary of said at least one reference data item cluster in said coordinate system.

7. The method according to claim 1, further comprising a procedure of constructing a database of said reference gas chromatographic data, acquired from a plurality of compounds, where each compound is acquired from a source that is known to be associated with either one of a healthy medical condition, and an adverse medical condition.

8. The method according to claim 6, wherein said procedure of determining is based on the number of accumulated occurrences in each of said position of respective said observed data item in relation to said defined boundary of said reference data item cluster.

9. The method according to claim 7, further comprising a procedure of establishing a set of criteria to define which said reference data item constitutes at least part of said reference data item cluster.

10. The method according to claim 1, wherein said at least one shape attribute is selected from a list consisting of:
a characteristic shape parameter in said modeling function;
a characteristic scale parameter in said modeling function;
a maximum value of at least one of said probability distribution functions;
a mean parameter of said modeling function;
a rate parameter in said modeling function;
a variance of said modeling function;
a degree of asymmetry of said probability distribution function;
slopes of said probability distribution function at certain points in time; and
at least one constant in said modeling function.

11. The method according to claim 2, further comprising a procedure of defining an N-dimensional data space, where at least one dimension corresponds with said at least one temporal attribute, and each of the remaining dimensions in said N-dimensional data space respectively correspond with said at least one shape attribute.

12. The method according to claim 11, further comprising a procedure of representing said at least one observed chromatographic peak as respective observed data item and said at least one reference chromatographic peak as respective reference data item in said N-dimensional data space.

13. The method according to claim 12, further comprising a procedure of performing statistical analysis on said acquired gas chromatographic data in said N-dimensional data space so as to assess whether said observed chromatographic peak is associated with at least one biomarker that is indicative of either one of a healthy medical condition, an adverse medical condition, and an indeterminate medical condition, associated with a subject from whom said sample is acquired.

14. The method according to claim 1, wherein a threshold value is defined for said degree of correspondence between said observed value and said reference value of said at least one temporal attribute, where if said degree of correspondence is above said threshold value it is supposed that there is no association between respective said observed chromatographic peak and said reference chromatographic peak, and if said degree of correspondence is below said threshold value it is supposed that there is an association between respective said reference chromatographic peak and said observed chromatographic peak.

15. The method according to claim 13, wherein said statistical analysis is facilitated by at least one decision rule that is based on the incidence of correspondences, between said observed data item and said reference data item, according to at least one statistical criterion.

16. A self-reliant gas chromatography system for analysis of gas chromatographic data, the system comprising:
a chromatographic separation column for separating a sample into a plurality of constituents, said chromatographic separation column includes an inlet and an outlet;
a sample delivery device coupled with said chromatographic separation column at said inlet, for providing said sample to said chromatographic separation column;
a detector in communication with said outlet of said chromatographic separation column for detecting at least a portion of said plurality of constituents, said detector producing a signal that includes said gas chromatographic data corresponding to characteristics of the detected said at least a portion of said sample, said gas chromatographic data including at least one observed chromatographic peak characterized by at least one temporal attribute and at least one observed shape attribute;
a memory device for storing said gas chromatographic data and a plurality of gas chromatographic reference data, said gas chromatographic reference data including at least one reference chromatographic peak characterized by at least one temporal attribute and at least one reference shape attribute; and
a processor coupled with said detector and with said memory device, said processor determines respectively, for said at least one observed chromatographic peak, at least one parameter in a modeling function, such to substantially fit said modeling function to said at least one observed chromatographic peak, said at least one parameter includes at least one of said at least one shape attribute, said processor associates respectively, for said at least one observed chromatographic peak said at least one reference chromatographic peak according to:
a degree of correspondence between an observed value of said at least one shape attribute of said at least one observed chromatographic peak, and a reference value of respective said at least one shape attribute of said at least one reference chromatographic peak; and
a degree of correspondence between an observed value of said at least one temporal attribute of said at least one observed chromatographic peak, and a reference value of respective said at least one reference temporal attribute of said at least one reference chromatographic peak; and
said processor estimates respectively, for said at least one observed chromatographic peak, said measure of match according to a degree of fitness between said observed value and respective said reference value of said at least one shape attribute.

17. The system according to claim 16, wherein said processor said estimates further according to a degree of fitness between said observed value and said reference value of corresponding said at least one temporal attribute.

18. The system according to claim 16, wherein said processor further represents, for said at least one observed chromatographic peak, in a coordinate system whose first coordinate is said at least one shape attribute and whose second coordinate is said at least one temporal attribute, a respective observed data item having a first coordinate that is said observed value of said at least one shape attribute, and a second coordinate that is said observed value of said at least one temporal attribute, such to define a position of said observed data item in said coordinate system.

19. The system according to claim 18, wherein said processor further represents in said coordinate system, for said at least one reference chromatographic peak, a respective reference data item having a first coordinate that is said reference value of said at least one shape attribute and a second coordinate that is said reference value of said at least one temporal attribute, such to define a position of said reference data item is said coordinate system.

20. The system according to claim 19, wherein said processor further identifies, in said coordinate system, at least one reference data item cluster that includes a plurality of reference data items all of whose respective reference chromatographic peaks are associated with a biomarker that is indicative of either one of a healthy medical condition, and adverse medical condition, and an indeterminate medical condition of a subject from whom said sample is acquired.

21. The system according to claim 20, wherein said processor determines for said at least one observed data item in said coordinate system, whether its respective said observed chromatographic peak is associated with at least one said biomarker that is indicative of either one of a healthy medical condition, an adverse medical condition, and an indeterminate medical condition, according to said position of said at least one observed data item in said coordinate system in relation to a defined boundary of said at least one reference data item cluster in said coordinate system.

22. The system according to claim 16, wherein said processor constructs a database in said memory device said reference gas chromatographic data, acquired from a plurality of compounds, where each compound is acquired from a source that is known to be associated with either one of a healthy medical condition, and an adverse medical condition.

23. The system according to claim 21, wherein said processor determines for said at least one observed data item in said coordinate system, whether its respective said observed chromatographic peak is associated with at least one said biomarker that is indicative of either one of a healthy medical condition, an adverse medical condition, and an indeterminate medical condition according to the number of accumulated occurrences in each of said position of respective said observed data item in relation to said defined boundary of said reference data item cluster.

24. The system according to claim 16, wherein said processor establishes a set of criteria to define which said reference data item constitutes at least part of said reference data item cluster.

25. The system according to claim 16, wherein said at least one shape attribute is selected from a list consisting of:
a characteristic shape parameter in said modeling function;
a characteristic scale parameter in said modeling function;
a maximum value of at least one of said probability distribution functions;
a rate parameter in said modeling function;
a variance of said modeling function;
a degree of asymmetry of said probability distribution function;
slopes of said probability distribution function at certain points in time; and
at least one constant in said modeling function.

26. The system according to claim 17, wherein an N-dimensional data space is defined, where at least one dimension corresponds with said at least one temporal attribute, and each of the remaining dimensions in said N-dimensional data space respectively correspond with said at least one shape attribute.

27. The system according to claim 26, wherein said processor represents at least one observed chromatographic peak as respective observed data item, and said at least one reference chromatographic peak as respective reference data item in said N-dimensional data space.

28. The system according to claim 27, wherein said processor performs statistical analysis on said acquired gas chromatographic data in said N-dimensional data space so as to assess whether said observed chromatographic peak is associated with at least one biomarker that is indicative of either one of a healthy medical condition, an adverse medical condition, and an indeterminate medical condition, associated with a subject from whom said sample is acquired.

29. The system according to claim 16, wherein a threshold value is defined for said degree of correspondence between said observed value and said reference value of said at least one temporal attribute, where if said degree of correspondence is above said threshold value it is supposed that there is no association between respective said observed chromatographic peak and said reference chromatographic peak, and if said degree of correspondence is below said threshold value it is supposed that there is an association between respective said reference chromatographic peak and said observed chromatographic peak.

30. The system according to claim 28, wherein said statistical analysis is facilitated by at least one decision rule that is based on the incidence of correspondences, between said observed data item and said reference data item, according to at least one statistical criterion.
